(19) United States
(12) Patent Application Publication
(10) Pub. No.: US 2015/0186843 A1
(43) Pub. Date: Jul. 2, 2015

(54) IDENTIFYING FINANCIAL DOCUMENTS FOR REIMAGING

(71) Applicant: Bank of America Corporation, Charlotte, NC (US)

(72) Inventors: Jeffrey R. Goertz, Liberty, MO (US); Brenda H. McChesney, Charlotte, NC (US); Deborah J. Adams, Charlotte, NC (US)

(73) Assignee: Bank of America Corporation, Charlotte, NC (US)

(21) Appl. No.: 14/146,145

(22) Filed: Jan. 2, 2014

(51) Int. Cl. G06Q 10/10

(52) U.S. Cl. CPC G06Q 10/10

(57) ABSTRACT

A message comprising information that identifies one or more physical financial documents for reimaging may be received. One or more records comprising the information that identifies the one or more physical financial documents for reimaging may be generated and stored. A message comprising information that identifies a plurality of physical financial documents contemporaneously received by a storage facility for physical financial documents may be received. At least one physical financial document of the plurality of physical financial documents contemporaneously received by the storage facility for physical financial documents that is identified by the one or more records comprising the information that identifies the one or more physical financial documents for reimaging may be identified from amongst the plurality of physical financial documents contemporaneously received by the storage facility for physical financial documents.

### BACKGROUND

Many financial institutions create digital images of financial documents. For example, financial institutions may create digital images of financial documents to aid in processing transactions associated with the financial documents, to preserve a copy of the financial documents for recordkeeping, and/or to reduce or eliminate the need to physically retain the financial documents. Periodically, however, a digital image of a financial document will prove unsuitable and the financial document will require reimaging. Reimaging the financial document may require identifying and locating the financial document. Often, however, the financial document will have been moved during the intervening period between when the original image was created and when a determination is made that the financial document requires reimaging. Accordingly, a need exists for identifying financial documents for reimaging.

### SUMMARY

The following presents a simplified summary in order to provide a basic understanding of some aspects of the disclosure. This summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In accordance with one or more embodiments, a computing platform may receive a message comprising information that identifies one or more physical financial documents for reimaging from a computing device associated with an image processing center for physical financial documents. The computing platform may generate one or more records comprising the information that identifies the one or more physical financial documents for reimaging and may store the one or more records comprising the information that identifies the one or more physical financial documents for reimaging. The computing platform may receive a message comprising information that identifies a plurality of physical financial documents contemporaneously received by a storage facility for physical financial documents from a computing device associated with the storage facility for physical financial documents. Responsive to receiving the message comprising the information that identifies the plurality of physical financial documents contemporaneously received by the storage facility for physical financial documents, the computing platform may utilize the information that identifies the plurality of physical financial documents contemporaneously received by the storage facility for physical financial documents to identify, from amongst the plurality of physical financial documents contemporaneously received by the storage facility for physical financial documents, at least one physical financial document of the plurality of physical financial documents contemporaneously received by the storage facility for physical financial documents that is identified by the one or more records comprising the information that identifies the one or more physical financial documents for reimaging.

In some embodiments, the computing platform may generate a message indicating that the at least one physical financial document of the plurality of physical financial documents contemporaneously received by the storage facility for physical financial documents requires reimaging. The computing platform may communicate the message indicating that the at least one physical financial document of the plurality of physical financial documents contemporaneously received by the storage facility for physical financial documents requires reimaging to a computing device associated with the storage facility for physical financial documents.

In some embodiments, the computing platform may receive information identifying a physical storage location within the storage facility for physical financial documents for each of the plurality of physical financial documents contemporaneously received by the storage facility for physical financial documents from a computing device associated with the storage facility for physical financial documents. The computing platform may utilize the information identifying a physical storage location within the storage facility for physical financial documents for each of the plurality of physical financial documents contemporaneously received by the storage facility for physical financial documents to determine one or more physical storage locations within the storage facility for physical financial documents where the at least one physical financial document of the plurality of physical financial documents contemporaneously received by the storage facility for physical financial documents is located within the storage facility for physical financial documents. The computing platform may generate a message comprising information identifying the one or more physical storage locations within the storage facility for physical financial documents where the at least one physical financial document of the plurality of physical financial documents contemporaneously received by the storage facility for physical financial documents is located within the storage facility for physical financial documents. The computing platform may communicate the message comprising the information identifying the one or more physical storage locations within the storage facility for physical financial documents where the at least one physical financial document of the plurality of physical financial documents contemporaneously received by the storage facility for physical financial documents is located within the storage facility for physical financial documents to a computing device associated with the storage facility for physical financial documents.

In some embodiments, a computing device associated with the storage facility for physical financial documents may generate a message comprising one or more digital images of the at least one physical financial document of the plurality of physical financial documents contemporaneously received by the storage facility for physical financial documents. A computing device associated with the storage facility for physical financial documents may communicate the message comprising the one or more digital images of the at least one physical financial document of the plurality of physical financial documents contemporaneously received by the storage facility for physical financial documents to a computing device associated with the image processing center for physical financial documents. A computing device associated with the image processing center for physical financial documents may generate a message indicating that the one or more digital images of the at least one physical financial document of the plurality of physical financial documents contemporaneously received by the storage facility for physical financial documents are suitable for processing or that the at least one physical financial document of the plurality of physical financial documents contemporaneously received by the storage facility for physical financial documents no longer requires reimaging. A computing device associated with the image processing center for physical financial documents may communicate the message indicating that the one or more digital images of the at least one physical financial document of the plurality of physical financial documents contemporaneously received by the storage facility for physical financial documents are suitable for processing or that the at least one physical financial document of the plurality of physical financial documents contemporaneously received by the storage facility for physical financial documents no longer requires reimaging to the computing platform.

In some embodiments, the computing platform may receive the message indicating that the one or more digital images of the at least one physical financial document of the plurality of physical financial documents contemporaneously received by the storage facility for physical financial documents are suitable for processing or that the at least one physical financial document of the plurality of physical financial documents contemporaneously received by the storage facility for physical financial documents no longer requires reimaging from a computing device associated with the image processing center for physical financial documents. Responsive to receiving the message indicating that the one or more digital images of the at least one physical financial document of the plurality of physical financial documents contemporaneously received by the storage facility for physical financial documents are suitable for processing or that the at least one physical financial document of the plurality of physical financial documents contemporaneously received by the storage facility for physical financial documents no longer requires reimaging, the computing platform may alter at least one of the one or more records comprising the information that identifies the one or more physical financial documents for reimaging to reflect that the at least one physical financial document of the plurality of physical financial documents contemporaneously received by the storage facility for physical financial documents no longer requires reimaging.

In some embodiments, the computing platform may generate one or more records comprising the information that identifies the plurality of physical financial documents contemporaneously received by the storage facility for physical financial documents. The computing platform may store the one or more records comprising the information that identifies the plurality of physical financial documents contemporaneously received by the storage facility for physical financial documents. Subsequent to storing the one or more records comprising the information that identifies the plurality of physical financial documents contemporaneously received by the storage facility for physical financial documents, the computing platform may receive a message comprising information that identifies one or more additional physical financial documents for reimaging from a computing device associated with the image processing center for physical financial documents. Responsive to receiving the message comprising the information that identifies the one or more additional physical financial documents for reimaging, the computing platform may: generate one or more records comprising the information that identifies the one or more additional physical financial documents for reimaging, store the one or more records comprising the information that identifies the one or more additional physical financial documents for reimaging; and utilize information from the one or more records comprising the information that identifies the plurality of physical financial documents contemporaneously received by the storage facility for physical financial documents to identify, from amongst the one or more additional physical financial documents for reimaging, at least one physical financial document of the one or more additional physical financial documents for reimaging that is identified by the one or more records comprising the information that identifies the plurality of physical financial documents contemporaneously received by the storage facility for physical financial documents.

In some embodiments, the computing platform may generate a message indicating that the at least one physical financial document of the one or more additional physical financial documents for reimaging requires reimaging. The computing platform may communicate the message indicating that the at least one physical financial document of the one or more additional physical financial documents for reimaging requires reimaging to a computing device associated with the storage facility for physical financial documents.

As indicated above, in some embodiments, the computing platform may receive information identifying a physical storage location within the storage facility for physical financial documents for each of the plurality of physical financial documents contemporaneously received by the storage facility for physical financial documents. The computing platform may utilize the information identifying a physical storage location within the storage facility for physical financial documents for each of the plurality of physical financial documents contemporaneously received by the storage facility for physical financial documents to determine one or more physical storage locations within the storage facility for physical financial documents where the at least one physical financial document of the one or more additional physical financial documents for reimaging is located within the storage facility for physical financial documents. The computing platform may generate a message comprising information identifying the one or more physical storage locations within the storage facility for physical financial documents where the at least one physical financial document of the one or more additional physical financial documents for reimaging is located within the storage facility for physical financial documents. The computing platform may communicate the message comprising the information identifying the one or more physical storage locations within the storage facility for physical financial documents where the at least one physical financial document of the one or more additional physical financial documents for reimaging is located within the storage facility for physical financial documents to a computing device associated with the storage facility for physical financial documents.

In some embodiments, a computing device associated with the storage facility for physical financial documents may generate a message comprising one or more digital images of the at least one physical financial document of the one or more additional physical financial documents for reimaging. A computing device associated with the storage facility for physical financial documents may communicate the message comprising the one or more digital images of the at least one physical financial document of the one or more additional physical financial documents for reimaging to a computing device associated with the image processing center for physical financial documents. A computing device associated with the image processing center for physical financial documents may generate a message indicating that the one or more digital images of the at least one physical financial document of the one or more additional physical financial documents for reimaging are suitable for processing or that the at least one physical financial document of the one or more additional physical financial documents for reimaging no longer requires reimaging. A computing device associated with the image processing center for physical financial documents may communicate the message indicating that the one or more digital images of the at least one physical financial document of the one or more additional physical financial documents for reimaging are suitable for processing or that the at least one physical financial document of the one or more additional physical financial documents for reimaging no longer requires reimaging to the computing platform.

In some embodiments, the computing platform may receive the message indicating that the one or more digital images of the at least one physical financial document of the one or more additional physical financial documents for reimaging are suitable for processing or that the at least one physical financial document of the one or more additional physical financial documents for reimaging no longer requires reimaging from a computing device associated with the image processing center for physical financial documents. Responsive to receiving the message indicating that the one or more digital images of the at least one physical financial document of the one or more additional physical financial documents for reimaging are suitable for processing or that the at least one physical financial document of the one or more additional physical financial documents for reimaging no longer requires reimaging, the computing platform may alter at least one of the one or more records comprising the information that identifies the one or more additional physical financial documents for reimaging to reflect that the at least one physical financial document of the one or more additional physical financial documents no longer requires reimaging.

In some embodiments, the computing platform may receive a message comprising information that identifies a plurality of physical financial documents contemporaneously received by a different storage facility for physical financial documents from a computing device associated with the different storage facility for physical financial documents. The different storage facility for physical financial documents may be located in a different geographic area from the storage facility for physical financial documents. Responsive to receiving the message comprising the information that identifies the plurality of physical financial documents contemporaneously received by the different storage facility for physical financial documents, the computing platform may utilize the information that identifies the plurality of physical financial documents contemporaneously received by the different storage facility for physical financial documents to identify, from amongst the plurality of physical financial documents contemporaneously received by the different storage facility for physical financial documents, at least one physical financial document of the plurality of physical financial documents contemporaneously received by the different storage facility for physical financial documents that is identified by the one or more records comprising the information that identifies the one or more physical financial documents for reimaging.

In some embodiments, the computing platform may generate a message indicating that the at least one physical financial document of the plurality of physical financial documents contemporaneously received by the different storage facility for physical financial documents requires reimaging. The computing platform may communicate the message indicating that the at least one physical financial document of the plurality of physical financial documents contemporaneously received by the different storage facility for physical financial documents requires reimaging to a computing device associated with the different storage facility for physical financial documents.

In some embodiments, the computing platform may receive information identifying a physical storage location within the different storage facility for physical financial documents for each of the plurality of physical financial documents contemporaneously received by the different storage facility for physical financial documents from a computing device associated with the different storage facility for physical financial documents. The computing platform may utilize the information identifying a physical storage location within the different storage facility for physical financial documents for each of the plurality of physical financial documents contemporaneously received by the different storage facility for physical financial documents to determine one or more physical storage locations within the different storage facility for physical financial documents where the at least one physical financial document of the plurality of physical financial documents contemporaneously received by the different storage facility for physical financial documents is located within the different storage facility for physical financial documents. The computing platform may generate a message comprising information identifying the one or more physical storage locations within the different storage facility for physical financial documents where the at least one physical financial document of the plurality of physical financial documents contemporaneously received by the different storage facility for physical financial documents is located within the different storage facility for physical financial documents. The computing platform may communicate the message comprising the information identifying the one or more physical storage locations within the different storage facility for physical financial documents where the at least one physical financial document of the plurality of physical financial documents contemporaneously received by the different storage facility for physical financial documents is located within the different storage facility for physical financial documents to a computing device associated with the different storage facility for physical financial documents.

In some embodiments, a computing device associated with the different storage facility for physical financial documents may generate a message comprising one or more digital images of the at least one physical financial document of the plurality of physical financial documents contemporaneously received by the different storage facility for physical financial documents. A computing device associated with the different storage facility for physical financial documents may communicate the message comprising the one or more digital images of the at least one physical financial document of the plurality of physical financial documents contemporaneously received by the different storage facility for physical financial documents to a computing device associated with the image processing center for physical financial documents. A computing device associated with the image processing center for physical financial documents may generate a message indicating that the one or more digital images of the at least one physical financial document of the plurality of physical financial documents contemporaneously received by the different storage facility for physical financial documents are suitable for processing or that the at least one physical financial document of the plurality of physical financial documents contemporaneously received by the different storage facility for physical financial documents no longer requires reimaging. A computing device associated with the image processing center for physical financial documents may communicate the message indicating that the one or more digital images of the at least one physical financial document of the plurality of physical financial documents contemporaneously received by the different storage facility for physical financial documents are suitable for processing or that the at least one physical financial document of the plurality of physical financial documents contemporaneously received by the different storage facility for physical financial documents no longer requires reimaging to the computing platform.

In some embodiments, the computing platform may receive the message indicating that the one or more digital images of the at least one physical financial document of the plurality of physical financial documents contemporaneously received by the different storage facility for physical financial documents are suitable for processing or that the at least one physical financial document of the plurality of physical financial documents contemporaneously received by the different storage facility for physical financial documents no longer requires reimaging from a computing device associated with the image processing center for physical financial documents. Responsive to receiving the message indicating that the one or more digital images of the at least one physical financial document of the plurality of physical financial documents contemporaneously received by the different storage facility for physical financial documents are suitable for processing or that the at least one physical financial document of the plurality of physical financial documents contemporaneously received by the different storage facility for physical financial documents no longer requires reimaging, the computing platform may alter at least one of the one or more records comprising the information that identifies the one or more physical financial documents for reimaging to reflect that the at least one physical financial document of the plurality of physical financial documents contemporaneously received by the different storage facility for physical financial documents no longer requires reimaging.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for identifying financial documents for reimaging in accordance with one or more example embodiments;

FIGS. 4A, 4B, 4C, 4D, 4E, 4F, 4G, 4H, 4I, 4J, 4K, and 4L depict an illustrative event sequence for identifying financial documents for reimaging in accordance with one or more example embodiments; and

FIG. 5 depicts an illustrative method for identifying financial documents for reimaging in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

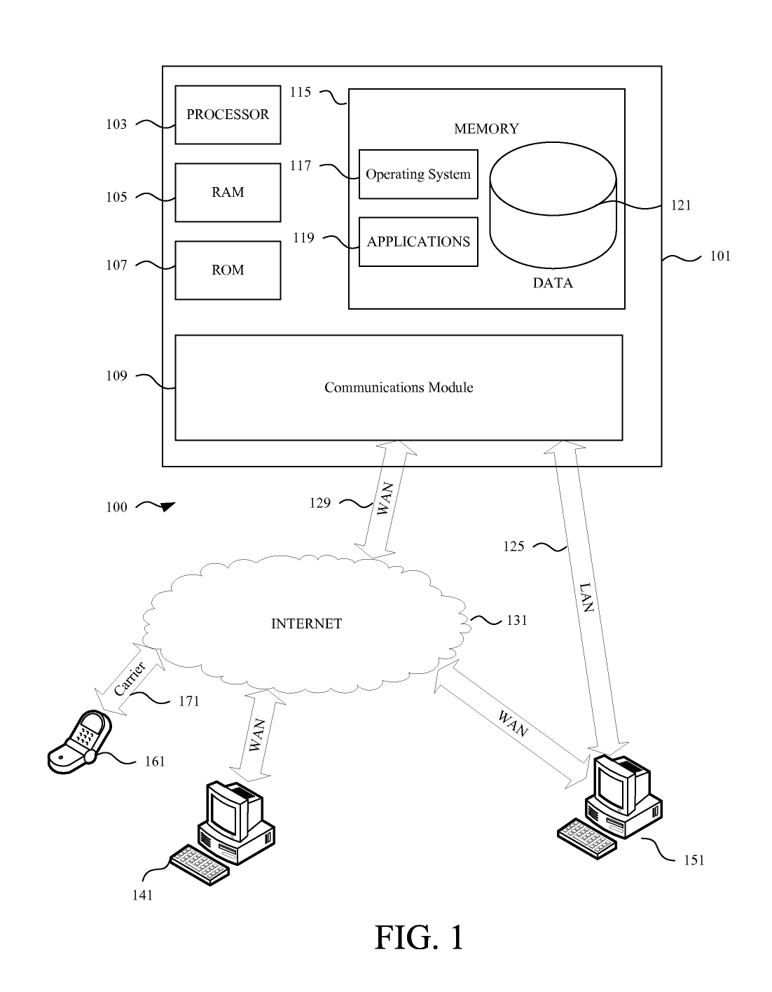

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

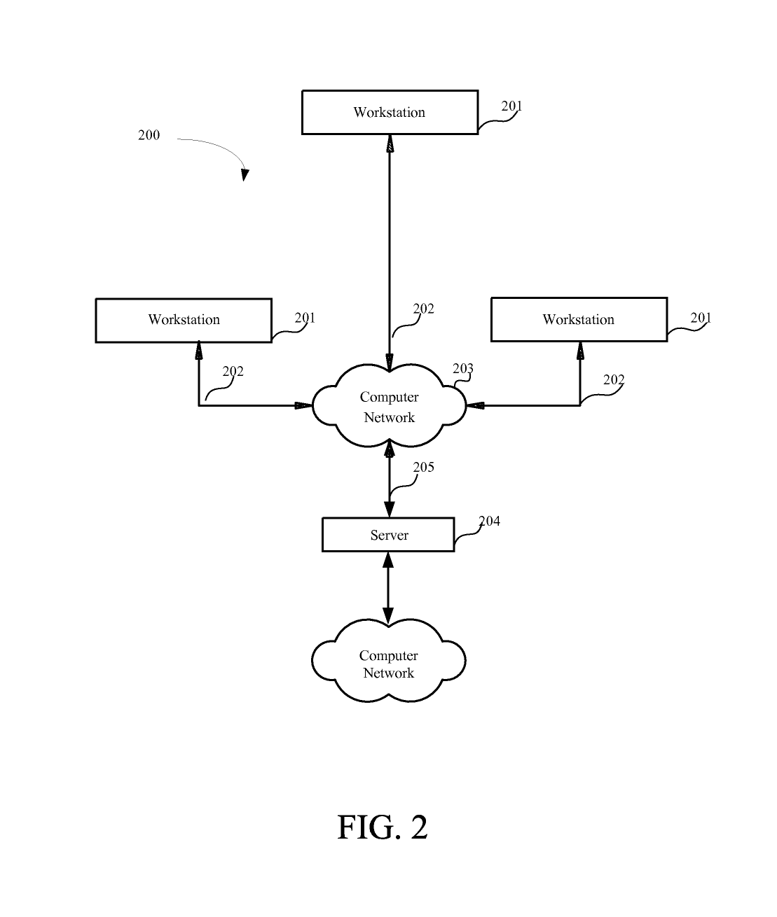

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

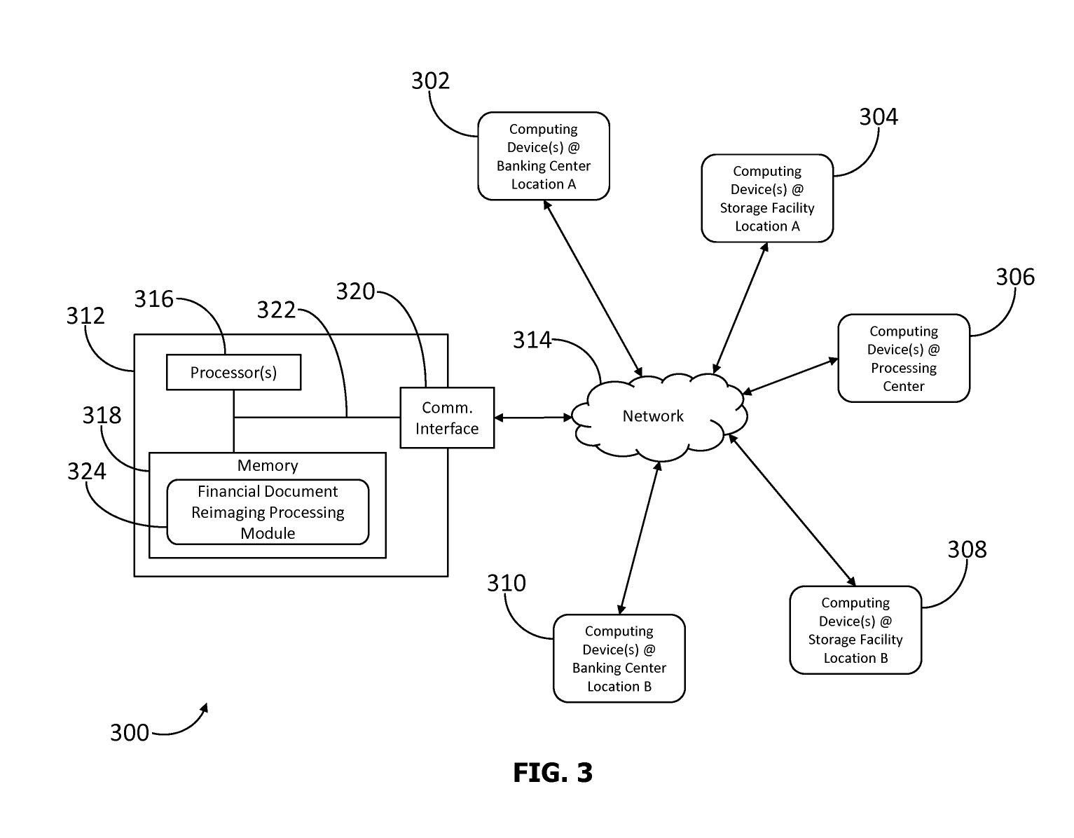

FIG. 3 depicts an illustrative computing environment for identifying financial documents for reimaging in accordance with one or more example embodiments. Referring to FIG. 3, computing environment 300 may include one or more computing platforms and/or computing devices. For example, computing environment 300 may include computing devices 302, 304, 306, 308, and 310, and computing platform 312. Computing environment 300 may also include one or more networks. For example, computing environment 300 may include network 314. Network 314 may interconnect one or more of computing devices 302, 304, 306, 308, and 310, and computing platform 312. In some embodiments, network 314 may include one or more sub-networks (e.g., LANs and/or WANs). Computing environment 300 may be associated with a financial institution, and one or more of computing devices 302, 304, 306, 308, and 310 may be associated with different aspects of the financial institution. For example, computing devices 302 may be associated with a first banking center location (e.g., a branch, automated teller machine (ATM), or the like). Similarly, computing devices 310 may be associated with a second banking center location (e.g., a different branch, ATM, or the like). The first banking center location and the second banking center location may be located in different geographic areas (e.g., Location “A” and Location “B”). Computing devices 302 and 310 may include one or more computing devices configured to generate digital images of physical financial documents received at their respective locations and communicate the digital images of the physical financial documents to one or more other computing devices within computing environment 300 (e.g., computing devices 306 via network 314).

Computing devices 304 may be associated with a storage facility for physical financial documents that is located in a first geographic area (e.g., Location “A”). The storage facility located in the first geographic area may receive physical financial documents from one or more banking center locations (e.g., banking center locations associated with computing devices 302 and/or 310) and retain the physical financial documents for a period of time (e.g., a predetermined retention period and/or until a determination is made that the physical financial documents no longer need to be retained). Similarly, computing devices 308 may be associated with a storage facility for physical financial documents that is located in a second geographic area (e.g., Location “B”). The first geographic area and the second geographic area may be different geographic areas (e.g., Location “A” and Location “B”). The storage facility located in the second geographic area may receive physical financial documents from one or more banking center locations (e.g., banking center locations associated with computing devices 302 and/or 310) and retain the physical financial documents for a period of time (e.g., a predetermined retention period and/or until a determination is made that the physical financial documents no longer need to be retained). Computing devices 304 and 308 may include one or more computing devices configured to generate digital images of physical financial documents stored at their respective locations and communicate the digital images of the physical financial documents to one or more other computing devices within computing environment 300 (e.g., computing devices 306 via network 314).

Computing devices 306 may be associated with an image processing center of the financial institution. One or more of computing devices 306 may be configured to receive digital images of physical financial documents (e.g., from one or more of computing devices 302 and/or 310) and determine whether the digital images of the physical financial documents are suitable for processing. As will be described in greater detail below, one or more of computing devices 306 may be configured to communicate information identifying one or more physical financial documents that require reimaging (e.g., in response to determining that one or more digital images of the physical financial documents is not suitable for processing). One or more of computing devices 306 may be configured to receive digital images of physical financial documents from one or more of computing devices 304 and/or 308 (e.g., reimages) and determine whether the digital images of the physical financial documents are suitable for processing. Moreover, as will be described in greater detail below, one or more of computing devices 306 may be configured to communicate information indicating that the digital images of physical financial documents received from computing devices 304 and/or 308 (e.g., the reimages) are suitable for processing and/or that reimaging is no longer required for the physical financial documents.

One or more of computing devices 302, 304, 306, 308, and 310, and computing platform 312 may include one or more processors and a memory storing executable instructions that when executed by the processor(s) cause the performance of one or more of the functions described herein. For example, computing platform 312 may include processor(s) 316, memory 318, communication interface 320, and data bus 322. Communication interface 320 may interface computing platform 312 with one or more networks (e.g., network 314) and support intercommunication with one or more other computing devices and/or computing platforms (e.g., computing devices 302, 304, 306, 308, and/or 310). Data bus 322 may interconnect processor(s) 316, memory 318, and communication interface 320. Memory 318 may include one or more program modules comprising executable instructions that when executed by processor(s) 316 cause computing platform 312 to perform one or more functions described herein. For example, memory 318 may include financial document reimaging processing module 324. Financial document reimaging processing module 324 may comprise executable instructions that when executed by processor(s) 316 cause computing platform 312 to perform one or more functions described herein. For example, financial document reimaging processing module 324 may comprise executable instructions that when executed by processor(s) 316 cause computing platform 312 to receive a message comprising information that identifies one or more physical financial documents for reimaging from a computing device associated with an image processing center for physical financial documents (e.g., one or more of computing devices 306). The instructions may further cause computing platform 312 to generate one or more records comprising the information that identifies the one or more physical financial documents for reimaging and store the one or more records comprising the information that identifies the one or more physical financial documents for reimaging (e.g., in memory 318).

The instructions may also cause computing platform 312 to receive a message comprising information that identifies a plurality of physical financial documents contemporaneously received by a storage facility for physical financial documents from a computing device associated with the storage facility for physical financial documents (e.g., one or more of computing devices 304). In response to receiving the message comprising the information that identifies the plurality of physical financial documents contemporaneously received by the storage facility for physical financial documents, the instructions may further cause computing platform 312 to utilize the information that identifies the plurality of physical financial documents contemporaneously received by the storage facility for physical financial documents to identify, from amongst the plurality of physical financial documents contemporaneously received by the storage facility for physical financial documents, at least one physical financial document of the plurality of physical financial documents contemporaneously received by the storage facility for physical financial documents that is identified by the one or more records comprising the information that identifies the one or more physical financial documents for reimaging.

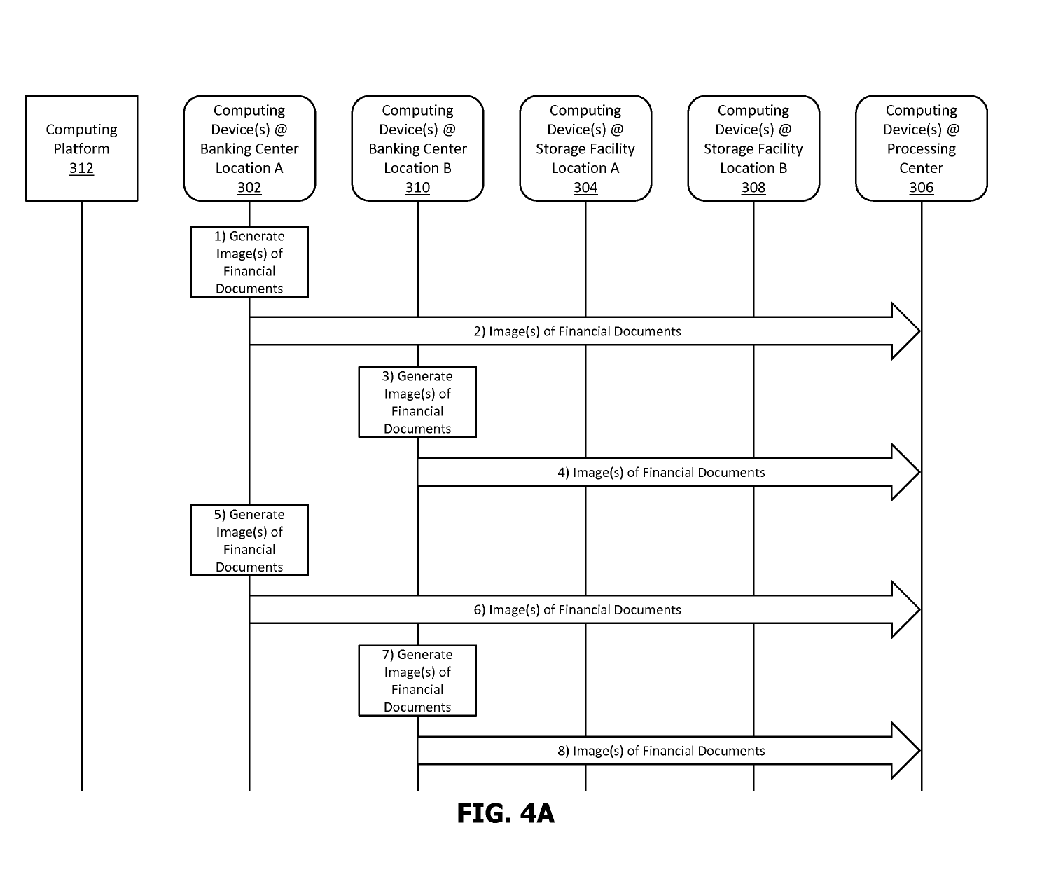

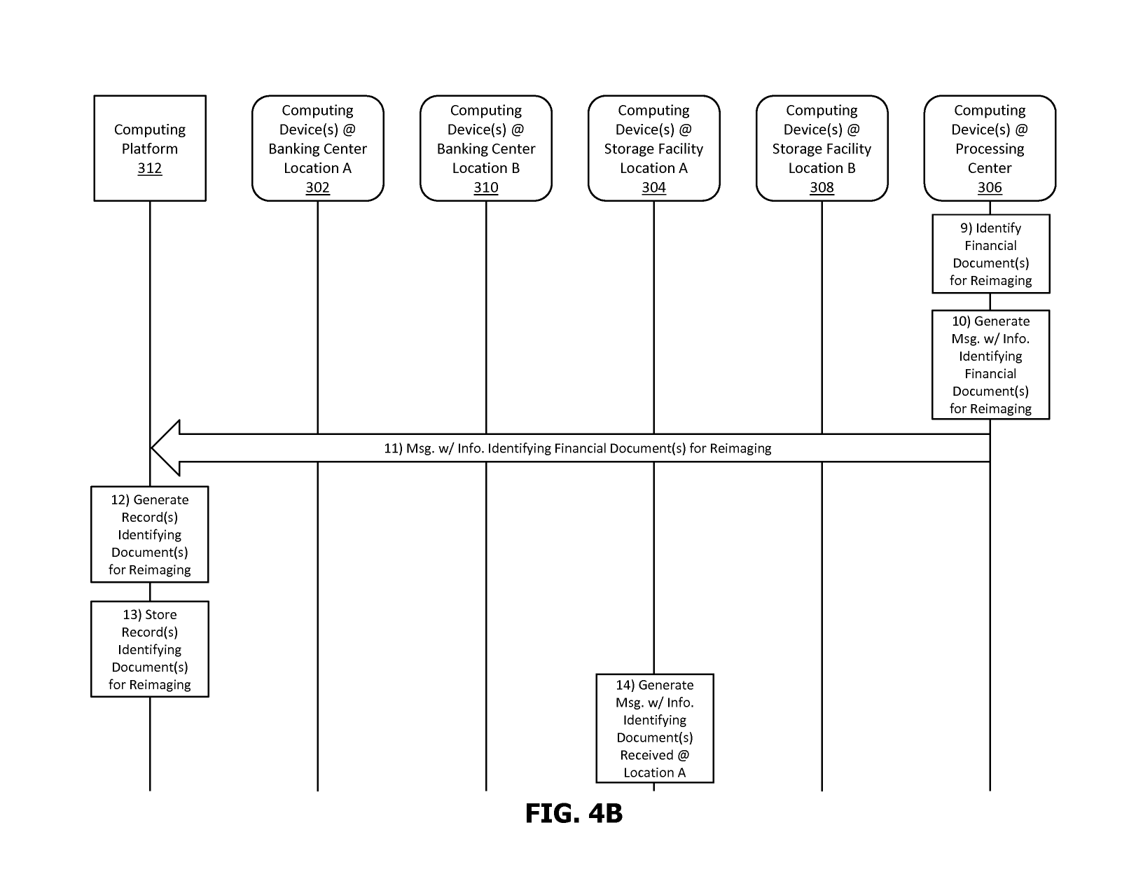

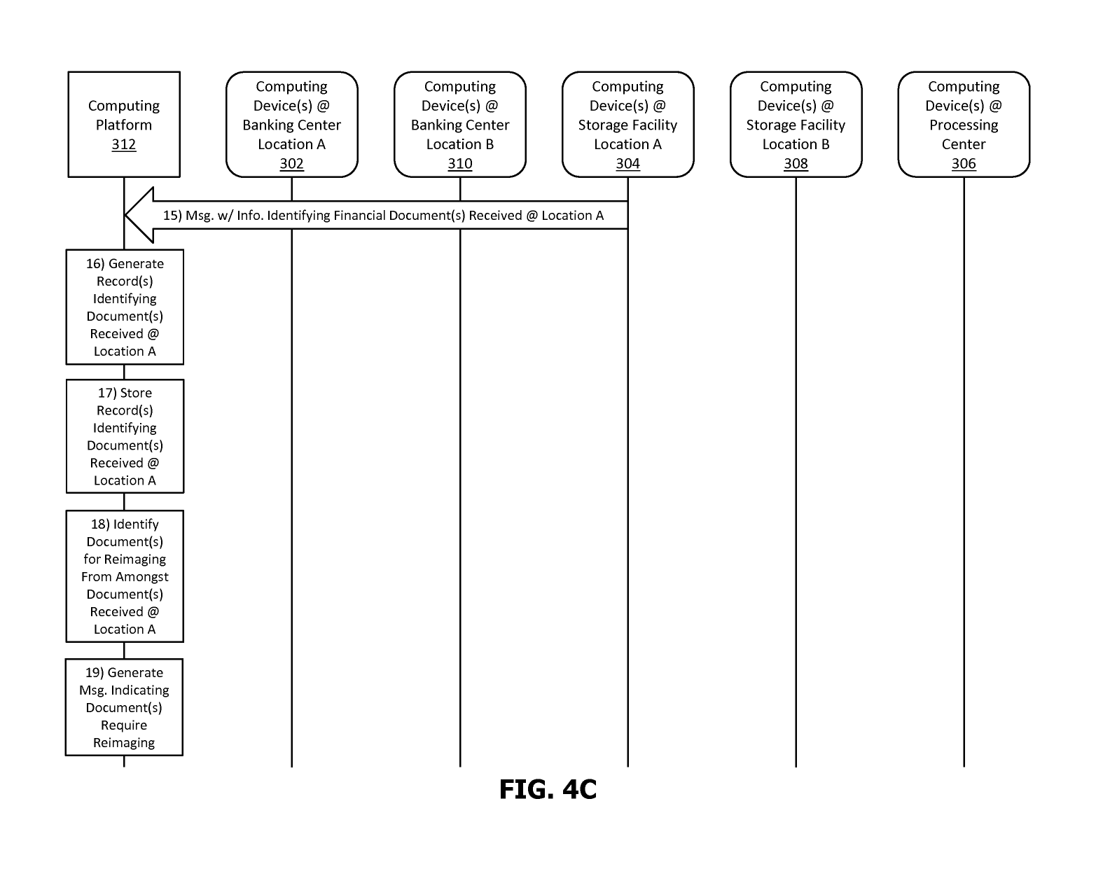

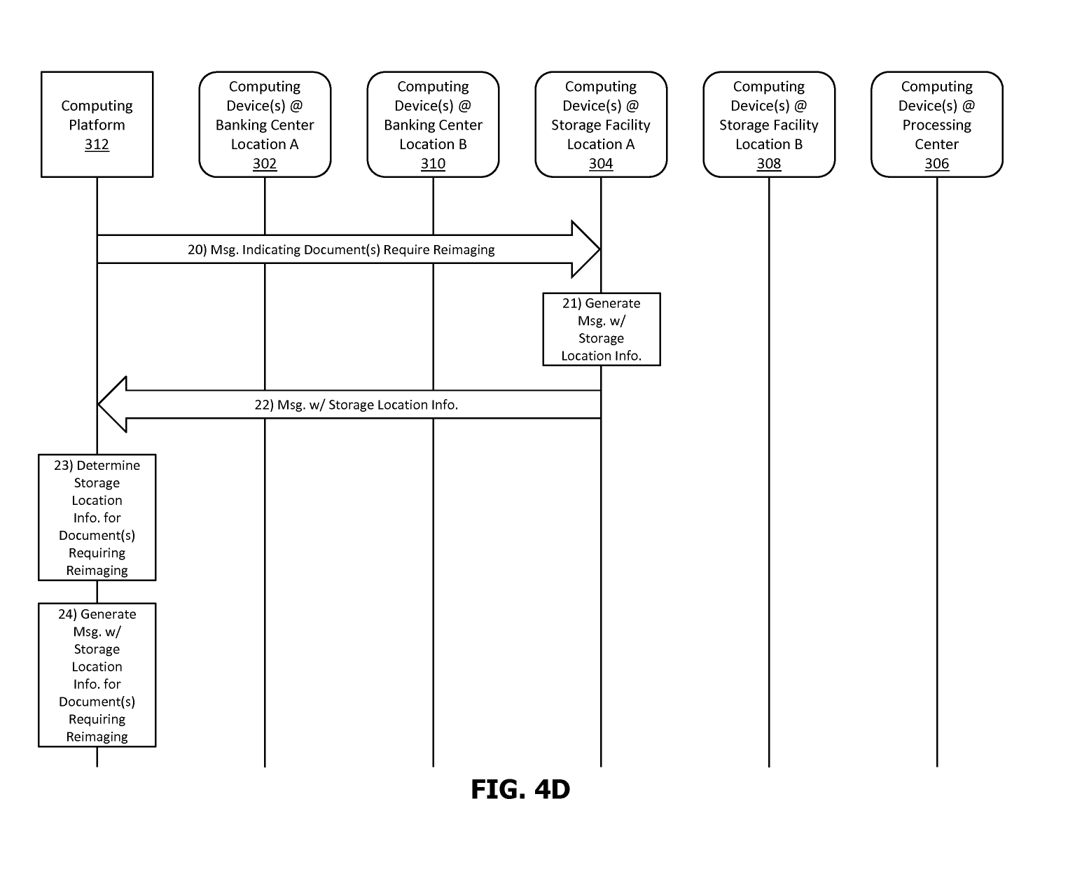

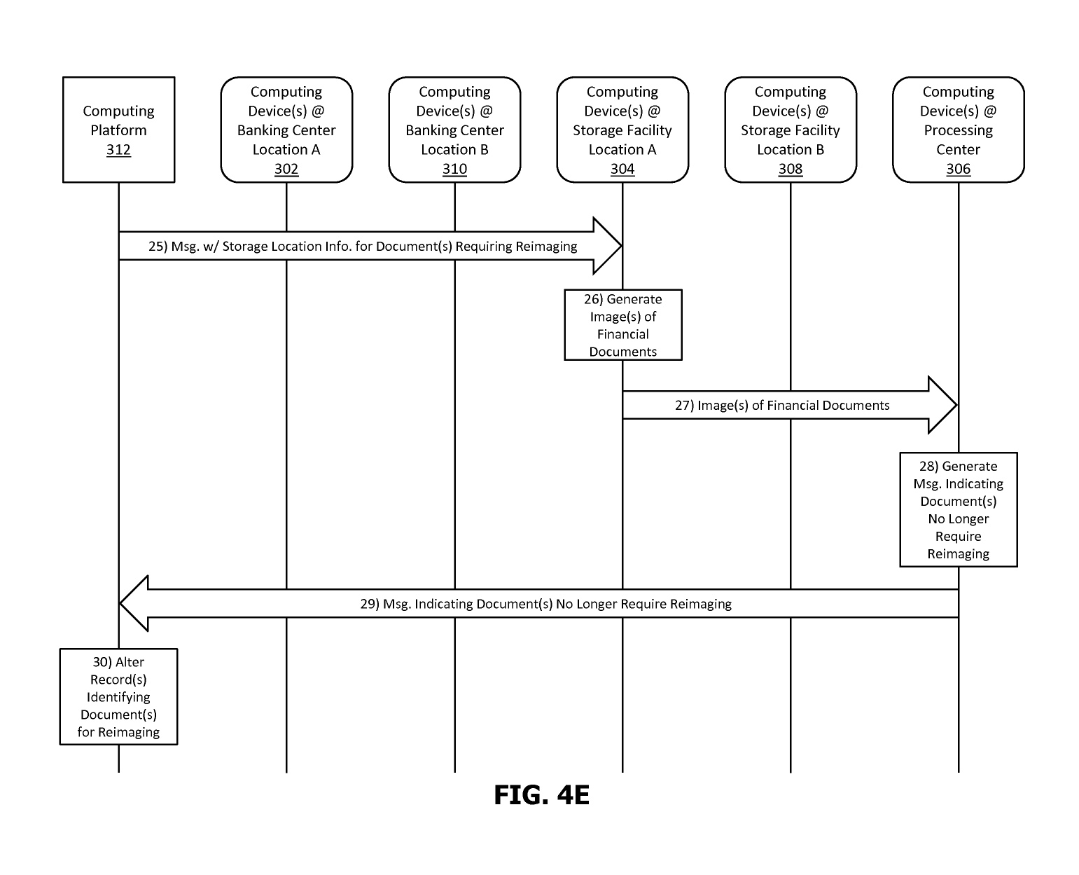

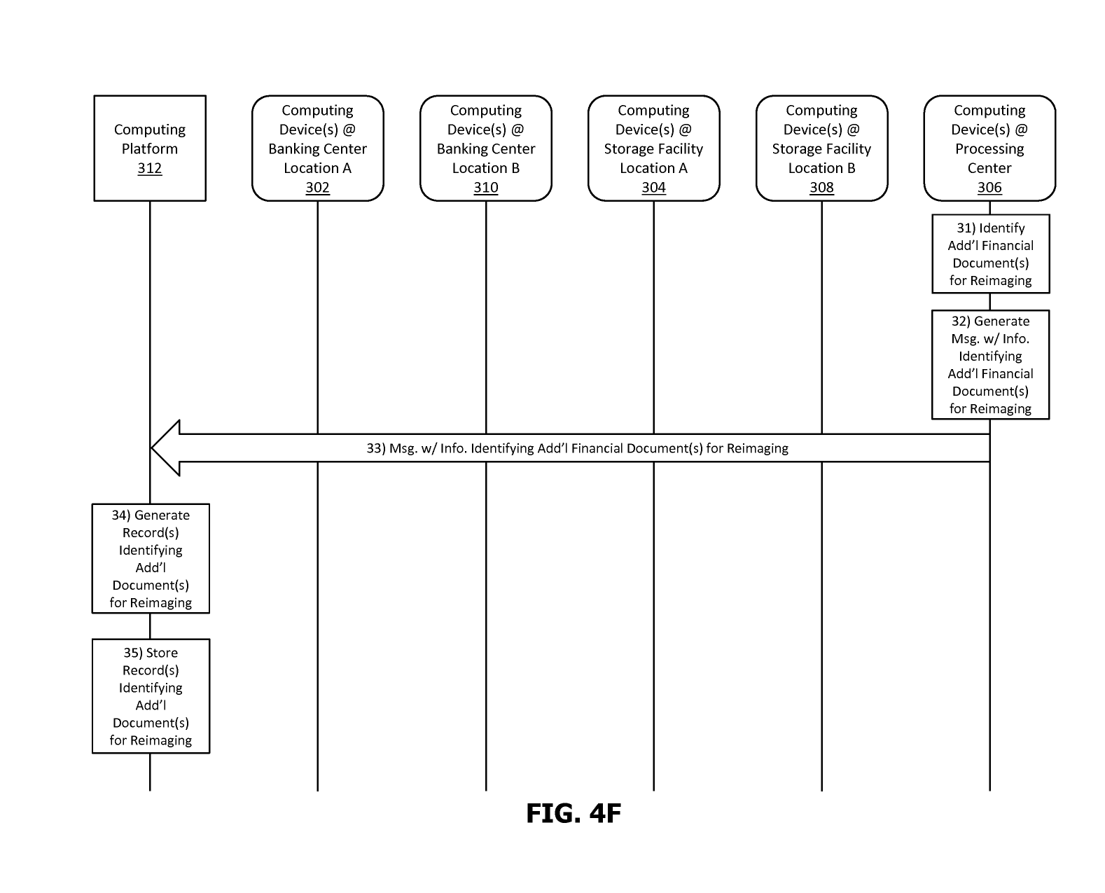

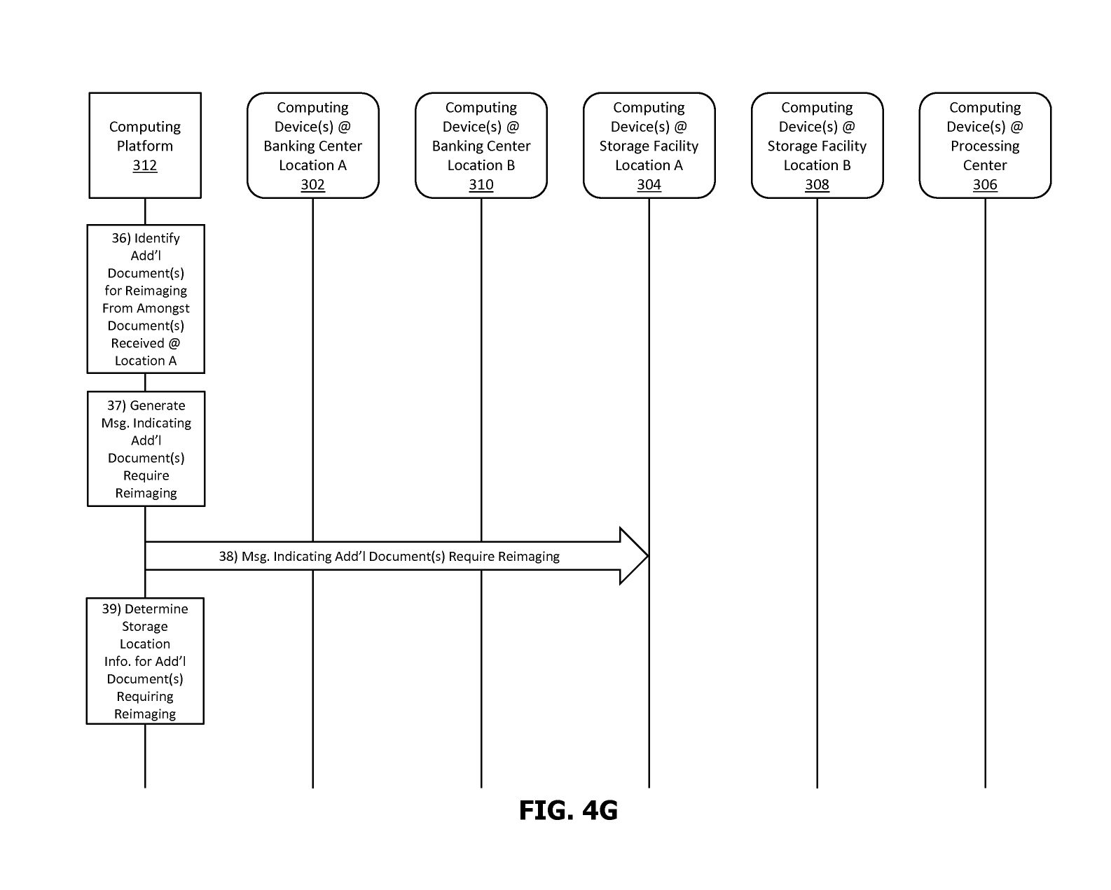

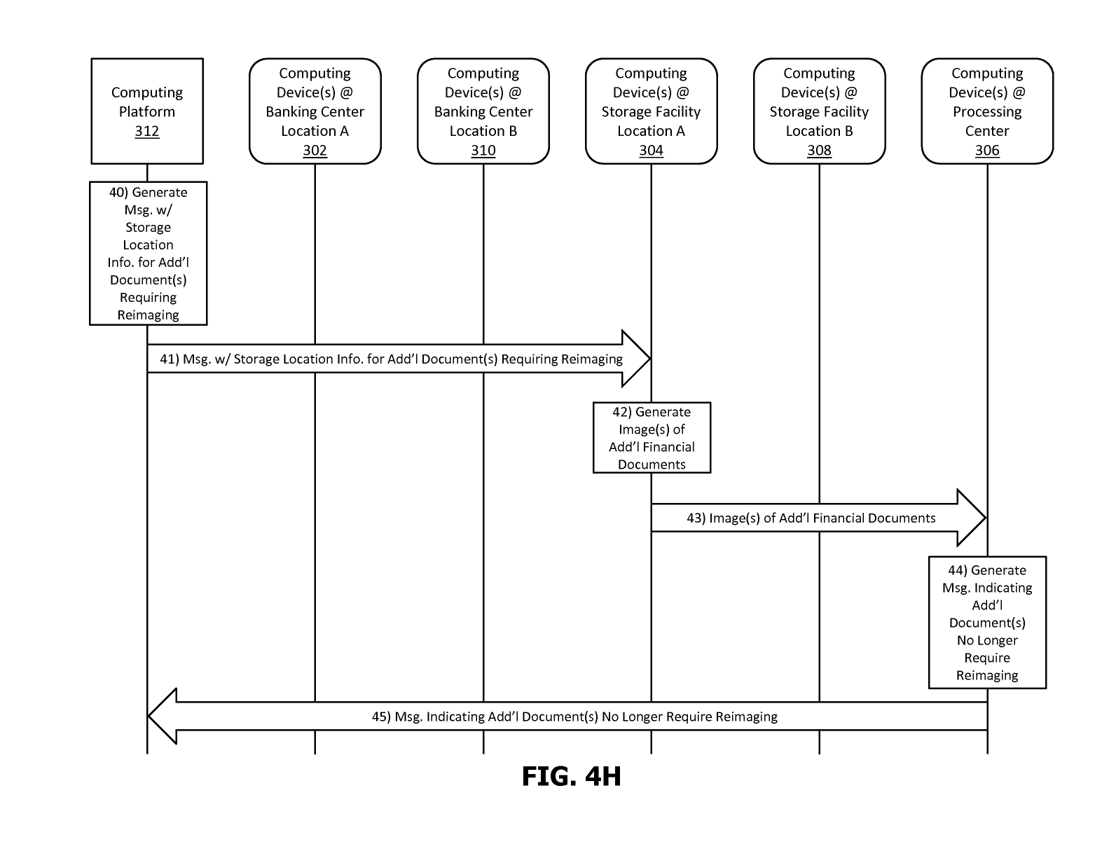

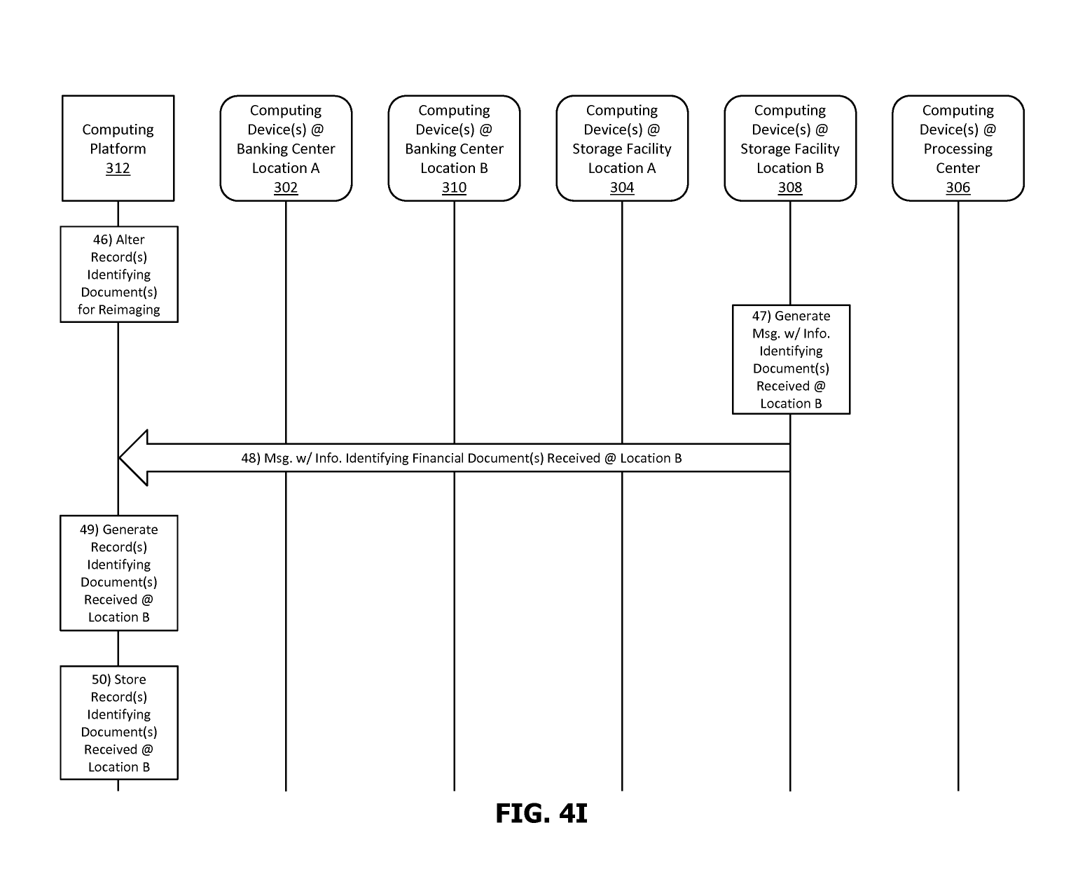

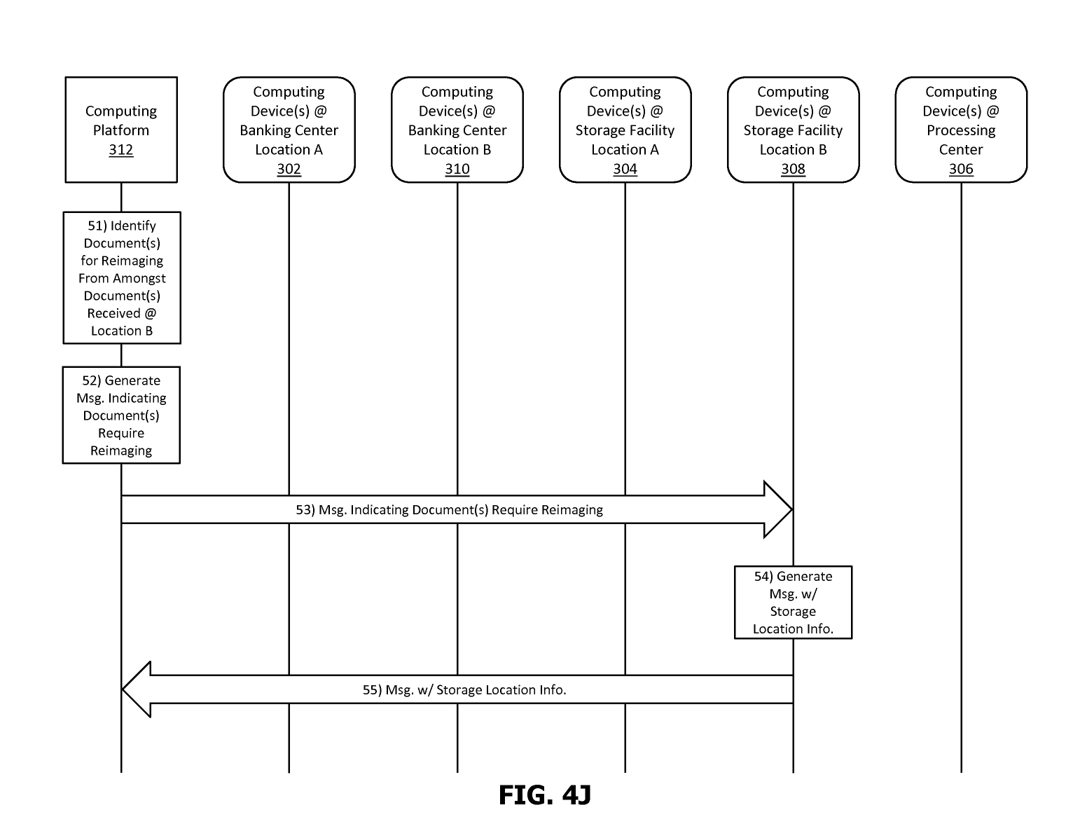

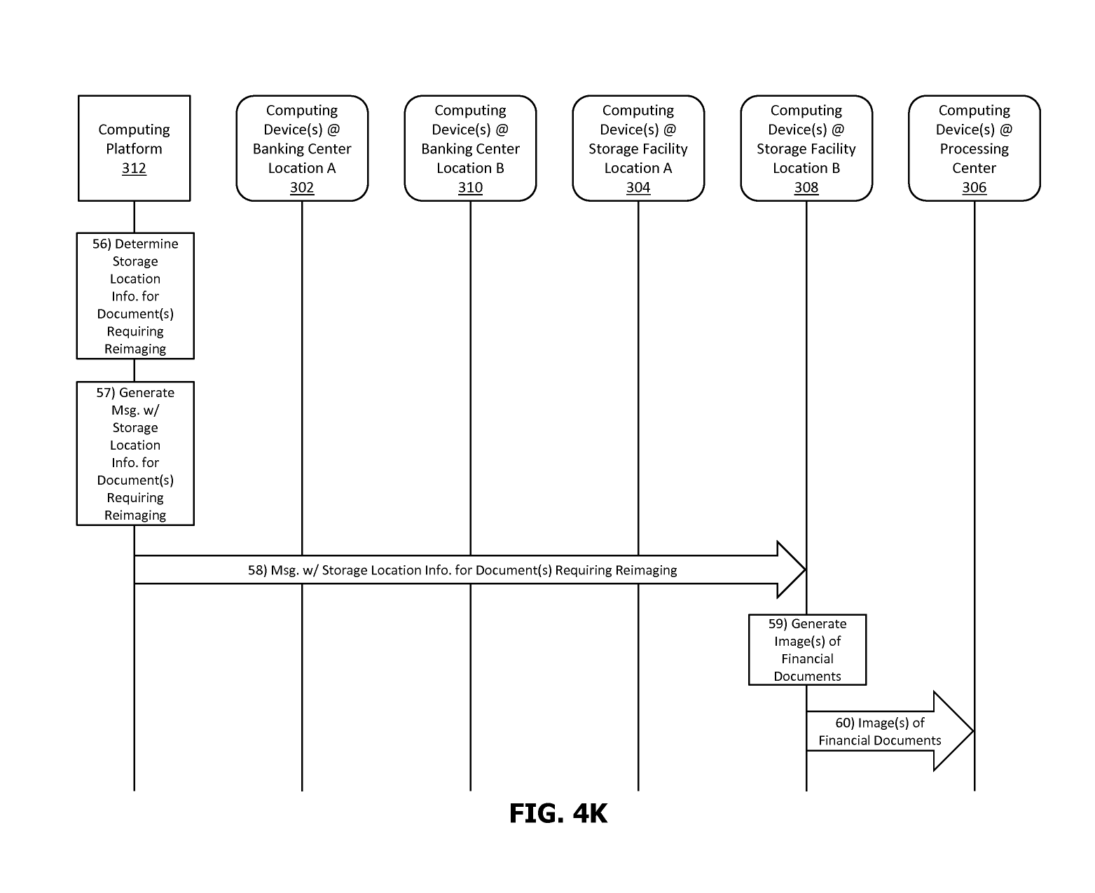

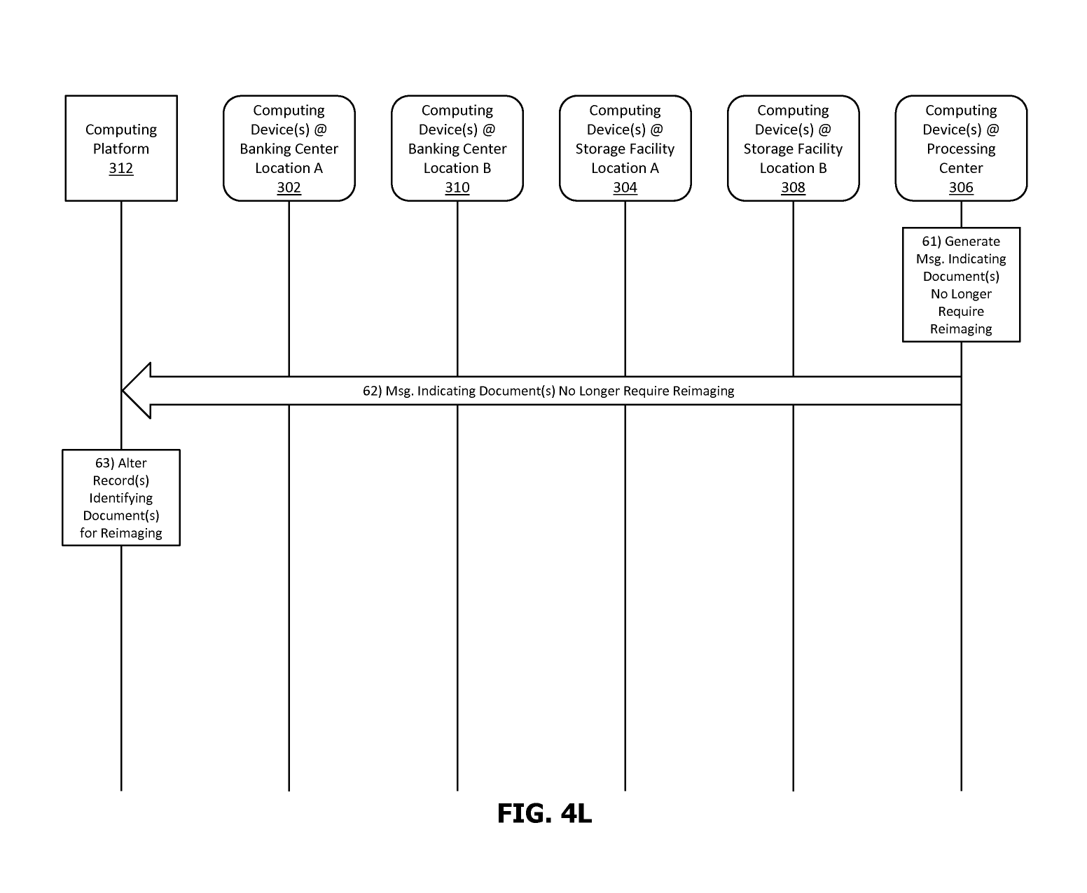

FIGS. 4A, 4B, 4C, 4D, 4E, 4F, 4G, 4H, 4I, 4J, 4K, and 4L depict an illustrative event sequence for identifying financial documents for reimaging in accordance with one or more example embodiments. Referring to FIG. 4A, at step 1, one or more of computing devices 302 may generate one or more digital images of physical financial documents. For example, a banking center location associated with computing devices 302 (e.g., in Location “A”) may be in physical possession of one or more physical financial documents (e.g., checks, deposit slips or tickets, general ledger slips or tickets, non-U.S. bank instruments, foreign currency, or the like) and one or more of computing devices 302 may be utilized by the banking center location to generate one or more digital images of the physical financial document(s). At step 2, one or more of computing devices 302 may communicate the digital image(s) of the physical financial document(s) to one or more of computing devices 306. For example, one or more of computing devices 302 may communicate the digital image(s) of the physical financial document(s) to one or more of computing devices 306 for further processing. At step 3, one or more of computing devices 310 may generate one or more digital images of physical financial documents. For example, a banking center location associated with computing devices 310 (e.g., in Location “B”) may be in physical possession of one or more physical financial documents (e.g., checks, deposit slips or tickets, general ledger slips or tickets, non-U.S. bank instruments, foreign currency, or the like) and one or more of computing devices 310 may be utilized by the banking center location to generate one or more digital images of the physical financial document(s). At step 4, one or more of computing devices 310 may communicate the digital image(s) of the physical financial document(s) to one or more of computing devices 306. For example, one or more of computing devices 310 may communicate the digital image(s) of the physical financial document(s) to one or more of computing devices 306 for further processing.

Similarly, at step 5, one or more of computing devices 302 may generate one or more digital images of physical financial documents. For example, a banking center location associated with computing devices 302 (e.g., in Location “A”) may be in physical possession of one or more additional physical financial documents (e.g., checks, deposit slips or tickets, general ledger slips or tickets, non-U.S. bank instruments, foreign currency, or the like) and one or more of computing devices 302 may be utilized by the banking center location to generate one or more digital images of the additional physical financial document(s). At step 6, one or more of computing devices 302 may communicate the digital image(s) of the additional physical financial document(s) to one or more of computing devices 306. For example, one or more of computing devices 302 may communicate the digital image(s) of the additional physical financial document(s) to one or more of computing devices 306 for further processing. At step 7, one or more of computing devices 310 may generate one or more digital images of physical financial documents. For example, a banking center location associated with computing devices 310 (e.g., in Location “B”) may be in physical possession of one or more additional physical financial documents (e.g., checks, deposit slips or tickets, general ledger slips or tickets, non-U.S. bank instruments, foreign currency, or the like) and one or more of computing devices 310 may be utilized by the banking center location to generate one or more digital images of the additional physical financial document(s). At step 8, one or more of computing devices 310 may communicate the digital image(s) of the additional physical financial document(s) to one or more of computing devices 306. For example, one or more of computing devices 310 may communicate the digital image(s) of the additional physical financial document(s) to one or more of computing devices 306 for further processing.

Referring to FIG. 4B, at step 9, one or more of computing devices 306 may identify one or more physical financial documents for reimaging. For example, as indicated above, computing devices 306 may be associated with an image processing center for a financial institution (e.g., a financial institution associated with the banking center locations associated with computing devices 302 and 310), and one or more of computing devices 306 may determine that one or more digital images of physical financial document(s) (e.g., one or more of the digital image(s) communicated to computing devices 306 in steps 2, 4, 6, and 8 above) are not suitable for processing and that the physical financial document(s) require reimaging. At step 10, one or more of computing devices 306 may generate a message comprising information that identifies the one or more physical financial documents for reimaging, and, at step 11, may communicate the message comprising the information that identifies the one or more physical financial documents for reimaging to computing platform 312. Computing platform 312 may receive the message comprising the information that identifies the one or more physical financial documents for reimaging (e.g., via communication interface 320), at step 12, may generate one or more records comprising the information that identifies the one or more physical financial documents for reimaging, and, at step 13, may store the one or more records comprising the information that identifies the one or more physical financial documents for reimaging (e.g., in memory 318).

At step 14, one or more of computing devices 304 may generate a message comprising information that identifies a plurality of physical financial documents contemporaneously received by a storage facility for physical financial documents. For example, a storage facility associated with computing devices 304 (e.g., a storage facility in Location “A”) may have physically received the physical financial documents for which digital images were previously generated (e.g., by computing devices 302 and 310 in steps 1 and 3 above), and may generate a message comprising information that identifies the received physical financial documents. Referring to FIG. 4C, at step 15, one or more of computing devices 304 may communicate the message comprising the information that identifies the plurality of physical financial documents contemporaneously received by the storage facility for physical financial documents to computing platform 312. Responsive to receiving the message comprising the information that identifies the plurality of physical financial documents contemporaneously received by the storage facility for physical financial documents (e.g., via communication interface 320), computing platform 312, at step 16, may generate one or more records comprising the information that identifies the plurality of physical financial documents contemporaneously received by the storage facility for physical financial documents, at step 17, may store the one or more records comprising the information that identifies the plurality of physical financial documents contemporaneously received by the storage facility for physical financial documents, and, at step 18, may utilize the information that identifies the plurality of physical financial documents contemporaneously received by the storage facility for physical financial documents to identify, from amongst the plurality of physical financial documents contemporaneously received by the storage facility for physical financial documents, at least one physical financial document of the plurality of physical financial documents contemporaneously received by the storage facility for physical financial documents that is identified by the one or more records comprising the information that identifies the one or more physical financial documents for reimaging. For example, computing platform 312 may generate one or more records comprising information that identifies the plurality of physical financial documents received by the storage facility associated with computing devices 304, may store the record(s) comprising the information that identifies the plurality of physical financial documents received by the storage facility associated with computing devices 304, and may utilize the information that identifies the plurality of physical financial documents received by the storage facility associated with computing devices 304 to identify, from amongst the plurality of physical financial documents received by the storage facility associated with computing devices 304, at least one physical financial document that is identified by the one or more records comprising the information that identifies the one or more physical financial documents for reimaging (e.g., the records generated and stored in steps 12 and 13 above). That is, computing platform 312 may identify at least one physical financial document of the physical financial documents received by the storage facility associated with computing devices 304 that requires reimaging.

At step 19, computing platform 312 may generate a message indicating that the at least one physical financial document of the plurality of physical financial documents contemporaneously received by the storage facility for physical financial documents requires reimaging. For example, computing platform 312 may generate a message indicating that the at least one physical financial document of the physical financial documents received by the storage facility associated with computing devices 304 requires reimaging. Referring to FIG. 4D, at step 20, computing platform 312 may communicate the message indicating that the at least one physical financial document of the plurality of physical financial documents contemporaneously received by the storage facility for physical financial documents requires reimaging to one or more of computing devices 304. At step 21, one or more of computing devices 304 may generate a message comprising information identifying a physical storage location within the storage facility for physical financial documents for each of the plurality of physical financial documents contemporaneously received by the storage facility for physical financial documents. For example, one or more of computing devices 304 may generate a message comprising information identifying a physical storage location within the storage facility associated with computing devices 304 (e.g., one or more of a lot number, rack number, tray number, or the like) for each of the physical financial documents received by the storage facility associated with computing devices 304. At step 22, one or more of computing devices 304 may communicate the message comprising the information identifying a physical storage location within the storage facility for physical financial documents for each of the plurality of physical financial documents contemporaneously received by the storage facility for physical financial documents to computing platform 312. For example, one or more of computing devices 304 may communicate the message comprising the information identifying a physical storage location within the storage facility associated with computing devices 304 (e.g., one or more of a lot number, rack number, tray number, or the like) for each of the physical financial documents received by the storage facility associated with computing devices 304 to computing platform 312.

Computing platform 312 may receive the message comprising the information identifying a physical storage location within the storage facility for physical financial documents for each of the plurality of physical financial documents contemporaneously received by the storage facility for physical financial documents, and at step 23, may utilize the information identifying a physical storage location within the storage facility for physical financial documents for each of the plurality of physical financial documents contemporaneously received by the storage facility for physical financial documents to determine one or more physical storage locations within the storage facility for physical financial documents where the at least one physical financial document of the plurality of physical financial documents contemporaneously received by the storage facility for physical financial documents is located within the storage facility for physical financial documents. For example, computing platform 312 may utilize the information identifying a physical storage location within the storage facility associated with computing devices 304 for each of the physical financial documents received by the storage facility associated with computing devices 304 to determine a physical storage location within the storage facility associated with computing devices 304 (e.g., one or more of a lot number, rack number, tray number, or the like) for each of the physical financial documents received by the storage facility associated with computing devices 304 that require reimaging.

At step 24, computing platform 312 may generate a message comprising information identifying the one or more physical storage locations within the storage facility for physical financial documents where the at least one physical financial document of the plurality of physical financial documents contemporaneously received by the storage facility for physical financial documents is located within the storage facility for physical financial documents, and, referring to FIG. 4E, at step 25, may communicate the message to one or more of computing devices 304. For example, computing platform 312 may generate a message comprising information identifying the physical storage location(s) within the storage facility associated with computing devices 304 for each of the physical financial documents received by the storage facility associated with computing devices 304 that require reimaging, and may communicate the message to one or more of computing devices 304. At step 26, one or more of computing devices 304 may generate a message comprising one or more digital images of the at least one physical financial document of the plurality of physical financial documents contemporaneously received by the storage facility for physical financial documents. For example, one or more of computing devices 304 may generate a message comprising one or more digital images of the physical financial documents received by the storage facility associated with computing devices 304 that require reimaging. At step 27, one or more of computing devices 304 may communicate the message comprising the one or more digital images of the at least one physical financial document of the plurality of physical financial documents contemporaneously received by the storage facility for physical financial documents to a computing device associated with the image processing center for physical financial documents. For example, one or more of computing devices 304 may communicate the message comprising the one or more digital images of the physical financial documents received by the storage facility associated with computing devices 304 that require reimaging to one or more of computing devices 306.

At step 28, one or more of computing devices 306 may generate a message indicating that the one or more digital images of the at least one physical financial document of the plurality of physical financial documents contemporaneously received by the storage facility for physical financial documents are suitable for processing or that the at least one physical financial document of the plurality of physical financial documents contemporaneously received by the storage facility for physical financial documents no longer requires reimaging. For example, one or more of computing devices 306 may have determined that the one or more digital images of the physical financial documents received by the storage facility associated with computing devices 304 that require reimaging are suitable for processing and/or that these physical financial documents no longer require reimaging, and may generate a message indicating that the one or more digital images of the physical financial documents received by the storage facility associated with computing devices 304 that require reimaging are suitable for processing and/or that these physical financial documents no longer require reimaging. At step 29, one or more of computing devices 306 may communicate the message indicating that the one or more digital images of the at least one physical financial document of the plurality of physical financial documents contemporaneously received by the storage facility for physical financial documents are suitable for processing or that the at least one physical financial document of the plurality of physical financial documents contemporaneously received by the storage facility for physical financial documents no longer requires reimaging to computing platform 312. For example, one or more of computing devices 306 may communicate the message indicating that the one or more digital images of the physical financial documents received by the storage facility associated with computing devices 304 that require reimaging are suitable for processing and/or that these physical financial documents no longer require reimaging to computing platform 312.

Computing platform 312 may receive the message indicating that the one or more digital images of the at least one physical financial document of the plurality of physical financial documents contemporaneously received by the storage facility for physical financial documents are suitable for processing or that the at least one physical financial document of the plurality of physical financial documents contemporaneously received by the storage facility for physical financial documents no longer requires reimaging, and, responsive to receiving the message indicating that the one or more digital images of the at least one physical financial document of the plurality of physical financial documents contemporaneously received by the storage facility for physical financial documents are suitable for processing or that the at least one physical financial document of the plurality of physical financial documents contemporaneously received by the storage facility for physical financial documents no longer requires reimaging, at step 30, may alter at least one of the one or more records comprising the information that identifies the one or more physical financial documents for reimaging to reflect that the at least one physical financial document of the plurality of physical financial documents contemporaneously received by the storage facility for physical financial documents no longer requires reimaging. For example, computing platform 312 may receive the message indicating that the one or more digital images of the physical financial documents received by the storage facility associated with computing devices 304 that require reimaging are suitable for processing and/or that these physical financial documents no longer require reimaging (e.g., via communication interface 320), and responsive to receiving the message indicating that the one or more digital images of the physical financial documents received by the storage facility associated with computing devices 304 that require reimaging are suitable for processing and/or that these physical financial documents no longer require reimaging, may alter one or more of the records comprising the information that identifies the one or more physical financial documents for reimaging (e.g., the records generated and stored in steps 12 and 13 above) to reflect that these physical financial documents no longer require reimaging.

Referring to FIG. 4F, at step 31, one or more of computing devices 306 may identify one or more additional physical financial documents for reimaging. For example, one or more of computing devices 306 may determine that one or more digital images of one or more additional physical financial documents (e.g., one or more of the digital image(s) communicated to computing devices 306 in steps 2, 4, 6, and 8 above) are not suitable for processing and that the one or more additional physical financial documents require reimaging. At step 32, one or more of computing devices 306 may generate a message comprising information that identifies the one or more additional physical financial documents for reimaging, and, at step 33, may communicate the message comprising the information that identifies the one or more additional physical financial documents for reimaging to computing platform 312. Computing platform 312 may receive the message comprising the information that identifies the one or more additional physical financial documents for reimaging (e.g., via communication interface 320), and responsive to receiving the message comprising the information that identifies the one or more additional physical financial documents for reimaging, computing platform 312, at step 34, may generate one or more records comprising the information that identifies the one or more additional physical financial documents for reimaging, at step 35, may store the one or more records comprising the information that identifies the one or more additional physical financial documents for reimaging (e.g., in memory 318), and, referring to FIG. 4G, at step 36, may utilize information from the one or more records comprising the information that identifies the plurality of physical financial documents contemporaneously received by the storage facility for physical financial documents (e.g., the information received in step 15 above) to identify, from amongst the one or more additional physical financial documents for reimaging, at least one physical financial document of the one or more additional physical financial documents for reimaging that is identified by the one or more records comprising the information that identifies the plurality of physical financial documents contemporaneously received by the storage facility for physical financial documents. For example, computing platform 312 may identify, from amongst the plurality of physical financial documents received at the storage facility associated with computing devices 304, one or more additional physical financial documents for reimaging.

At step 37, computing platform 312 may generate a message indicating that the at least one physical financial document of the one or more additional physical financial documents for reimaging requires reimaging, and, at step 38, may communicate the message indicating that the at least one physical financial document of the one or more additional physical financial documents for reimaging requires reimaging to computing devices 304. For example, computing platform 312 may generate a message indicating that the one or more additional physical financial documents of the plurality of physical financial documents received at the storage facility associated with computing devices 304 that require reimaging require reimaging, and may communicate the message to one or more of computing devices 304. At step 39, computing platform 312 may utilize the information identifying a physical storage location within the storage facility for physical financial documents for each of the plurality of physical financial documents contemporaneously received by the storage facility for physical financial documents to determine one or more physical storage locations within the storage facility for physical financial documents where the at least one physical financial document of the one or more additional physical financial documents for reimaging is located within the storage facility for physical financial documents. For example, computing platform 312 may utilize the information identifying a physical storage location within the storage facility associated with computing devices 304 for each of the plurality of physical financial documents contemporaneously received by the storage facility associated with computing devices 304 (e.g., the information received in step 22 above) to determine one or more physical storage locations within the storage facility associated with computing devices 304 (e.g., one or more of a lot number, rack number, tray number, or the like) for the one or more additional physical financial documents of the plurality of physical financial documents received at the storage facility associated with computing devices 304 that require reimaging.

Referring to FIG. 4H, at step 40, computing platform 312 may generate a message comprising information identifying the one or more physical storage locations within the storage facility for physical financial documents where the at least one physical financial document of the one or more additional physical financial documents for reimaging is located within the storage facility for physical financial documents, and, at step 41, may communicate the message comprising the information identifying the one or more physical storage locations within the storage facility for physical financial documents where the at least one physical financial document of the one or more additional physical financial documents for reimaging is located within the storage facility for physical financial documents to one or more of computing devices 304. For example, computing platform 312 may generate a message comprising information identifying the one or more physical storage locations within the storage facility associated with computing devices 304 (e.g., one or more of a lot number, rack number, tray number, or the like) for the one or more additional physical financial documents of the plurality of physical financial documents received at the storage facility associated with computing devices 304 that require reimaging, and may communicate the message to one or more of computing devices 304.

At step 42, one or more of computing devices 304 may generate a message comprising one or more digital images of the at least one physical financial document of the one or more additional physical financial documents for reimaging, and, at step 43, may communicate the message comprising the one or more digital images of the at least one physical financial document of the one or more additional physical financial documents for reimaging to one or more of computing devices 306. For example, one or more of computing devices 304 may generate a message comprising one or more digital images of the one or more additional physical financial documents of the plurality of physical financial documents received at the storage facility associated with computing devices 304 that require reimaging, and may communicate the message to one or more of computing devices 306. At step 44, one or more of computing devices 306 may generate a message indicating that the one or more digital images of the at least one physical financial document of the one or more additional physical financial documents for reimaging are suitable for processing or that the at least one physical financial document of the one or more additional physical financial documents for reimaging no longer requires reimaging, and, at step 45, may communicate the message indicating that the one or more digital images of the at least one physical financial document of the one or more additional physical financial documents for reimaging are suitable for processing or that the at least one physical financial document of the one or more additional physical financial documents for reimaging no longer requires reimaging to computing platform 312. For example, one or more of computing devices 306 may generate a message indicating that the one or more digital images of the one or more additional physical financial documents of the plurality of physical financial documents received at the storage facility associated with computing devices 304 that require reimaging are suitable for processing or that the one or more additional physical financial documents of the plurality of physical financial documents received at the storage facility associated with computing devices 304 that require reimaging no longer require reimaging, and may communicate the message to computing platform 312.

Computing platform 312 may receive the message indicating that the one or more digital images of the at least one physical financial document of the one or more additional physical financial documents for reimaging are suitable for processing or that the at least one physical financial document of the one or more additional physical financial documents for reimaging no longer requires reimaging (e.g., via communication interface 320), and, responsive to receiving the message indicating that the one or more digital images of the at least one physical financial document of the one or more additional physical financial documents for reimaging are suitable for processing or that the at least one physical financial document of the one or more additional physical financial documents for reimaging no longer requires reimaging, may, referring to FIG. 4I, at step 46, alter at least one of the one or more records comprising the information that identifies the one or more additional physical financial documents for reimaging to reflect that the at least one physical financial document of the one or more additional physical financial documents no longer requires reimaging. For example, computing platform 312 may receive the message indicating that the one or more digital images of the one or more additional physical financial documents of the plurality of physical financial documents received at the storage facility associated with computing devices 304 that require reimaging are suitable for processing or that the one or more additional physical financial documents of the plurality of physical financial documents received at the storage facility associated with computing devices 304 that require reimaging no longer require reimaging, and may, responsive to receiving the message, alter at least one of the one or more records comprising the information that identifies the one or more additional physical financial documents for reimaging (e.g., the record(s) generated and stored in steps 34 and 35 above) to reflect that that the one or more additional physical financial documents of the plurality of physical financial documents received at the storage facility associated with computing devices 304 that require reimaging no longer require reimaging.

At step 47, one or more of computing devices 308 may generate a message comprising information that identifies a plurality of physical financial documents contemporaneously received by a different storage facility for physical financial documents. For example, a storage facility associated with computing devices 308 (e.g., a storage facility in Location “B”) may have physically received the physical financial documents for which digital images were previously generated (e.g., by computing devices 302 and 310 in steps 5 and 7 above), and may generate a message comprising information that identifies the received physical financial documents. At step 48, one or more of computing devices 308 may communicate the message comprising the information that identifies the plurality of physical financial documents contemporaneously received by the different storage facility for physical financial documents to computing platform 312. Responsive to receiving the message comprising the information that identifies the plurality of physical financial documents contemporaneously received by the different storage facility for physical financial documents (e.g., via communication interface 320), computing platform 312, at step 49, may generate one or more records comprising the information that identifies the plurality of physical financial documents contemporaneously received by the different storage facility for physical financial documents, at step 50, may store the one or more records comprising the information that identifies the plurality of physical financial documents contemporaneously received by the different storage facility for physical financial documents, and, referring to FIG. 4J, at step 51, may utilize the information that identifies the plurality of physical financial documents contemporaneously received by the different storage facility for physical financial documents to identify, from amongst the plurality of physical financial documents contemporaneously received by the different storage facility for physical financial documents, at least one physical financial document of the plurality of physical financial documents contemporaneously received by the different storage facility for physical financial documents that is identified by the one or more records comprising the information that identifies the one or more physical financial documents for reimaging. For example, computing platform 312 may generate one or more records comprising information that identifies the plurality of physical financial documents received by the storage facility associated with computing devices 308, may store the record(s) comprising the information that identifies the plurality of physical financial documents received by the storage facility associated with computing devices 308, and may utilize the information that identifies the plurality of physical financial documents received by the storage facility associated with computing devices 308 to identify, from amongst the plurality of physical financial documents received by the storage facility associated with computing devices 308, at least one physical financial document that is identified by the one or more records comprising the information that identifies the one or more physical financial documents for reimaging (e.g., the records generated and stored in steps 12 and 13 above). That is, computing platform 312 may identify at least one physical financial document of the physical financial documents received by the storage facility associated with computing devices 308 that requires reimaging.

At step 52, computing platform 312 may generate a message indicating that the at least one physical financial document of the plurality of physical financial documents contemporaneously received by the different storage facility for physical financial documents requires reimaging. For example, computing platform 312 may generate a message indicating that the at least one physical financial document of the physical financial documents received by the storage facility associated with computing devices 308 requires reimaging. At step 53, computing platform 312 may communicate the message indicating that the at least one physical financial document of the plurality of physical financial documents contemporaneously received by the different storage facility for physical financial documents requires reimaging to one or more of computing devices 308. At step 54, one or more of computing devices 308 may generate a message comprising information identifying a physical storage location within the different storage facility for physical financial documents for each of the plurality of physical financial documents contemporaneously received by the different storage facility for physical financial documents. For example, one or more of computing devices 308 may generate a message comprising information identifying a physical storage location within the storage facility associated with computing devices 308 (e.g., one or more of a lot number, rack number, tray number, or the like) for each of the physical financial documents received by the storage facility associated with computing devices 308. At step 55, one or more of computing devices 308 may communicate the message comprising the information identifying a physical storage location within the different storage facility for physical financial documents for each of the plurality of physical financial documents contemporaneously received by the different storage facility for physical financial documents to computing platform 312. For example, one or more of computing devices 308 may communicate the message comprising the information identifying a physical storage location within the storage facility associated with computing devices 308 (e.g., one or more of a lot number, rack number, tray number, or the like) for each of the physical financial documents received by the storage facility associated with computing devices 308 to computing platform 312.

Computing platform 312 may receive the message comprising the information identifying a physical storage location within the different storage facility for physical financial documents for each of the plurality of physical financial documents contemporaneously received by the different storage facility for physical financial documents, and, referring to FIG. 4K, at step 56, may utilize the information identifying a physical storage location within the different storage facility for physical financial documents for each of the plurality of physical financial documents contemporaneously received by the different storage facility for physical financial documents to determine one or more physical storage locations within the different storage facility for physical financial documents where the at least one physical financial document of the plurality of physical financial documents contemporaneously received by the different storage facility for physical financial documents is located within the different storage facility for physical financial documents. For example, computing platform 312 may utilize the information identifying a physical storage location within the storage facility associated with computing devices 308 for each of the physical financial documents received by the storage facility associated with computing devices 308 to determine a physical storage location within the storage facility associated with computing devices 308 (e.g., one or more of a lot number, rack number, tray number, or the like) for each of the physical financial documents received by the storage facility associated with computing devices 308 that require reimaging.

At step 57, computing platform 312 may generate a message comprising information identifying the one or more physical storage locations within the different storage facility for physical financial documents where the at least one physical financial document of the plurality of physical financial documents contemporaneously received by the different storage facility for physical financial documents is located within the different storage facility for physical financial documents, and, at step 58, may communicate the message to one or more of computing devices 308. For example, computing platform 312 may generate a message comprising information identifying the physical storage location(s) within the storage facility associated with computing devices 308 for each of the physical financial documents received by the storage facility associated with computing devices 308 that require reimaging, and may communicate the message to one or more of computing devices 308. At step 59, one or more of computing devices 308 may generate a message comprising one or more digital images of the at least one physical financial document of the plurality of physical financial documents contemporaneously received by the different storage facility for physical financial documents. For example, one or more of computing devices 308 may generate a message comprising one or more digital images of the physical financial documents received by the storage facility associated with computing devices 308 that require reimaging. At step 60, one or more of computing devices 308 may communicate the message comprising the one or more digital images of the at least one physical financial document of the plurality of physical financial documents contemporaneously received by the different storage facility for physical financial documents to a computing device associated with the image processing center for physical financial documents. For example, one or more of computing devices 308 may communicate the message comprising the one or more digital images of the physical financial documents received by the storage facility associated with computing devices 308 that require reimaging to one or more of computing devices 306.

Referring to FIG. 4L, at step 61, one or more of computing devices 306 may generate a message indicating that the one or more digital images of the at least one physical financial document of the plurality of physical financial documents contemporaneously received by the different storage facility for physical financial documents are suitable for processing or that the at least one physical financial document of the plurality of physical financial documents contemporaneously received by the different storage facility for physical financial documents no longer requires reimaging. For example, one or more of computing devices 306 may have determined that the one or more digital images of the physical financial documents received by the storage facility associated with computing devices 308 that require reimaging are suitable for processing and/or that these physical financial documents no longer require reimaging, and may generate a message indicating that the one or more digital images of the physical financial documents received by the storage facility associated with computing devices 308 that require reimaging are suitable for processing and/or that these physical financial documents no longer require reimaging. At step 62, one or more of computing devices 306 may communicate the message indicating that the one or more digital images of the at least one physical financial document of the plurality of physical financial documents contemporaneously received by the different storage facility for physical financial documents are suitable for processing or that the at least one physical financial document of the plurality of physical financial documents contemporaneously received by the different storage facility for physical financial documents no longer requires reimaging to computing platform 312. For example, one or more of computing devices 306 may communicate the message indicating that the one or more digital images of the physical financial documents received by the storage facility associated with computing devices 308 that require reimaging are suitable for processing and/or that these physical financial documents no longer require reimaging to computing platform 312.

Computing platform 312 may receive the message indicating that the one or more digital images of the at least one physical financial document of the plurality of physical financial documents contemporaneously received by the different storage facility for physical financial documents are suitable for processing or that the at least one physical financial document of the plurality of physical financial documents contemporaneously received by the different storage facility for physical financial documents no longer requires reimaging, and, responsive to receiving the message indicating that the one or more digital images of the at least one physical financial document of the plurality of physical financial documents contemporaneously received by the different storage facility for physical financial documents are suitable for processing or that the at least one physical financial document of the plurality of physical financial documents contemporaneously received by the different storage facility for physical financial documents no longer requires reimaging, at step 63, may alter at least one of the one or more records comprising the information that identifies the one or more physical financial documents for reimaging to reflect that the at least one physical financial document of the plurality of physical financial documents contemporaneously received by the different storage facility for physical financial documents no longer requires reimaging. For example, computing platform 312 may receive the message indicating that the one or more digital images of the physical financial documents received by the storage facility associated with computing devices 308 that require reimaging are suitable for processing and/or that these physical financial documents no longer require reimaging (e.g., via communication interface 320), and responsive to receiving the message indicating that the one or more digital images of the physical financial documents received by the storage facility associated with computing devices 308 that require reimaging are suitable for processing and/or that these physical financial documents no longer require reimaging, may alter one or more of the records comprising the information that identifies the one or more physical financial documents for reimaging (e.g., the records generated and stored in steps 12 and 13 above) to reflect that these physical financial documents no longer require reimaging.

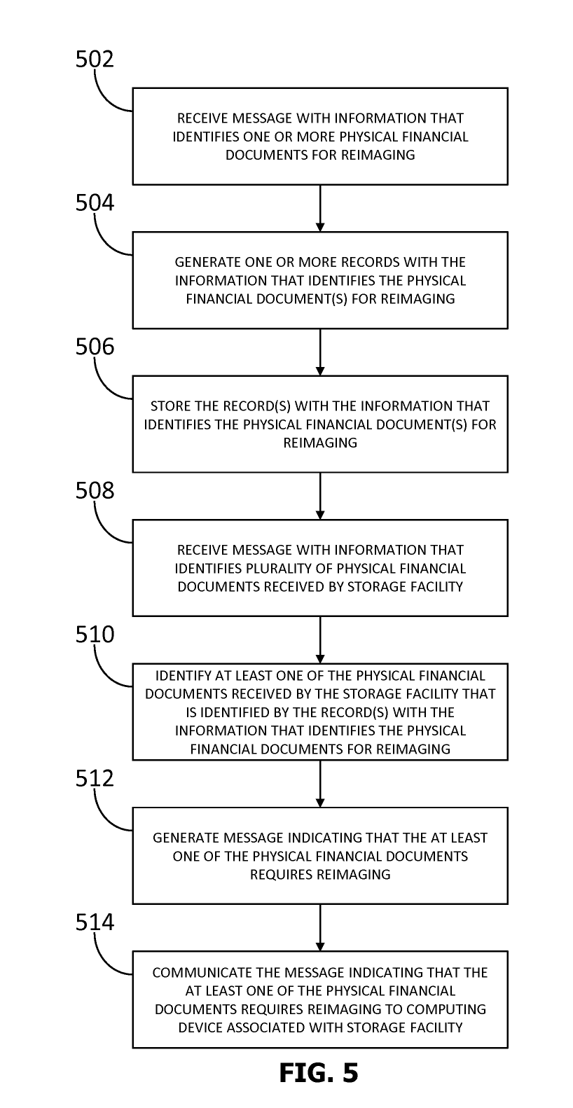

FIG. 5 depicts an illustrative method for identifying financial documents for reimaging in accordance with one or more example embodiments. Referring to FIG. 5, at step 502, a message comprising information that identifies one or more physical financial documents for reimaging may be received. For example, computing platform 312 may receive a message comprising information that identifies one or more physical financial documents for reimaging from one or more of computing devices 306. At step 504, one or more records comprising the information that identifies the one or more physical financial documents for reimaging may be generated. For example, computing platform 312 may generate one or more records comprising the information that identifies the one or more physical financial documents for reimaging received from the one or more of computing devices 306. At step 506, the one or more records comprising the information that identifies the one or more physical financial documents for reimaging may be stored. For example, computing platform 312 may store the one or more records comprising the information that identifies the one or more physical financial documents for reimaging received from the one or more of computing devices 306 (e.g., in memory 318). At step 508, a message comprising information that identifies a plurality of physical financial documents contemporaneously received by a storage facility for physical financial documents may be received. For example, computing platform 312 may receive a message comprising information that identifies a plurality of physical financial documents contemporaneously received by a storage facility for physical financial documents from one or more of computing devices 304.

At step 510, at least one physical financial document of the plurality of physical financial documents contemporaneously received by the storage facility for physical financial documents that is identified by the one or more records comprising the information that identifies the one or more physical financial documents for reimaging may be identified. For example, computing platform 312 may utilize the information, received from the one or more of computing devices 304, that identifies the plurality of physical financial documents contemporaneously received by the storage facility for physical financial documents, to identify, from amongst the plurality of physical financial documents contemporaneously received by the storage facility for physical financial documents, at least one physical financial document of the plurality of physical financial documents contemporaneously received by the storage facility for physical financial documents that is identified by the one or more records comprising the information, received from the one or more of computing devices 306, that identifies the one or more physical financial documents for reimaging. At step 512, a message indicating that the at least one physical financial document of the plurality of physical financial documents contemporaneously received by the storage facility for physical financial documents requires reimaging may be generated. For example, computing platform 312 may generate a message indicating that the at least one physical financial document of the plurality of physical financial documents contemporaneously received by the storage facility for physical financial documents that is identified by the one or more records comprising the information, received from the one or more of computing devices 306, that identifies the one or more physical financial documents for reimaging requires reimaging. At step 514, the message indicating that the at least one physical financial document of the plurality of physical financial documents contemporaneously received by the storage facility for physical financial documents requires reimaging may be communicated to a computing device associated with the storage facility for physical financial documents. For example, computing platform 312 may communicate the message indicating that the at least one physical financial document of the plurality of physical financial documents contemporaneously received by the storage facility for physical financial documents that is identified by the one or more records comprising the information, received from the one or more of computing devices 306, that identifies the one or more physical financial documents for reimaging requires reimaging to one or more of computing devices 304.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
receiving, via a communication interface of a computing platform and from a computing device associated with an image processing center for physical financial documents, a message comprising information that identifies one or more physical financial documents for reimaging;
generating, by at least one processor of the computing platform, one or more records comprising the information that identifies the one or more physical financial documents for reimaging;
storing, in a memory of the computing platform, the one or more records comprising the information that identifies the one or more physical financial documents for reimaging;
receiving, via a communication interface of the computing platform and from a computing device associated with a storage facility for physical financial documents, a message comprising information that identifies a plurality of physical financial documents contemporaneously received by the storage facility for physical financial documents; and
responsive to receiving the message comprising the information that identifies the plurality of physical financial documents contemporaneously received by the storage facility for physical financial documents, utilizing, by at least one processor of the computing platform, the information that identifies the plurality of physical financial documents contemporaneously received by the storage facility for physical financial documents to identify, from amongst the plurality of physical financial documents contemporaneously received by the storage facility for physical financial documents, at least one physical financial document of the plurality of physical financial documents contemporaneously received by the storage facility for physical financial documents that is identified by the one or more records comprising the information that identifies the one or more physical financial documents for reimaging.

2. The method of claim 1, comprising:
generating, by at least one processor of the computing platform, a message indicating that the at least one physical financial document of the plurality of physical financial documents contemporaneously received by the storage facility for physical financial documents requires reimaging; and
communicating, via a communication interface of the computing platform and to a computing device associated with the storage facility for physical financial documents, the message indicating that the at least one physical financial document of the plurality of physical financial documents contemporaneously received by the storage facility for physical financial documents requires reimaging.

3. The method of claim 1, comprising:
receiving, via a communication interface of the computing platform and from a computing device associated with the storage facility for physical financial documents, information identifying a physical storage location within the storage facility for physical financial documents for each of the plurality of physical financial documents contemporaneously received by the storage facility for physical financial documents; and
utilizing, by at least one processor of the computing platform, the information identifying a physical storage location within the storage facility for physical financial documents for each of the plurality of physical financial documents contemporaneously received by the storage facility for physical financial documents to determine one or more physical storage locations within the storage facility for physical financial documents where the at least one physical financial document of the plurality of physical financial documents contemporaneously received by the storage facility for physical financial documents is located within the storage facility for physical financial documents.

4. The method of claim 3, comprising:
generating, by at least one processor of the computing platform, a message comprising information identifying the one or more physical storage locations within the storage facility for physical financial documents where the at least one physical financial document of the plurality of physical financial documents contemporaneously received by the storage facility for physical financial documents is located within the storage facility for physical financial documents; and
communicating, via a communication interface of the computing platform and to a computing device associated with the storage facility for physical financial documents, the message comprising the information identifying the one or more physical storage locations within the storage facility for physical financial documents where the at least one physical financial document of the plurality of physical financial documents contemporaneously received by the storage facility for physical financial documents is located within the storage facility for physical financial documents.

5. The method of claim 1, comprising:
generating, by at least one processor of a computing device associated with the storage facility for physical financial documents, a message comprising one or more digital images of the at least one physical financial document of the plurality of physical financial documents contemporaneously received by the storage facility for physical financial documents; and
communicating, via a communication interface of a computing device associated with the storage facility for physical financial documents and to a computing device associated with the image processing center for physical financial documents, the message comprising the one or more digital images of the at least one physical financial document of the plurality of physical financial documents contemporaneously received by the storage facility for physical financial documents.

6. The method of claim 5, comprising:
generating, by at least one processor of a computing device associated with the image processing center for physical financial documents, a message indicating that the one or more digital images of the at least one physical financial document of the plurality of physical financial documents contemporaneously received by the storage facility for physical financial documents are suitable for processing or that the at least one physical financial document of the plurality of physical financial documents contemporaneously received by the storage facility for physical financial documents no longer requires reimaging; and
communicating, via a communication interface of a computing device associated with the image processing center for physical financial documents and to the computing platform, the message indicating that the one or more digital images of the at least one physical financial document of the plurality of physical financial documents contemporaneously received by the storage facility for physical financial documents are suitable for processing or that the at least one physical financial document of the plurality of physical financial documents contemporaneously received by the storage facility for physical financial documents no longer requires reimaging.

7. The method of claim 6, comprising:
receiving, via a communication interface of the computing platform and from a computing device associated with the image processing center for physical financial documents, the message indicating that the one or more digital images of the at least one physical financial document of the plurality of physical financial documents contemporaneously received by the storage facility for physical financial documents are suitable for processing or that the at least one physical financial document of the plurality of physical financial documents contemporaneously received by the storage facility for physical financial documents no longer requires reimaging; and
responsive to receiving the message indicating that the one or more digital images of the at least one physical financial document of the plurality of physical financial documents contemporaneously received by the storage facility for physical financial documents are suitable for processing or that the at least one physical financial document of the plurality of physical financial documents contemporaneously received by the storage facility for physical financial documents no longer requires reimaging, altering, by at least one processor of the computing platform, at least one of the one or more records comprising the information that identifies the one or more physical financial documents for reimaging to reflect that the at least one physical financial document of the plurality of physical financial documents contemporaneously received by the storage facility for physical financial documents no longer requires reimaging.

8. The method of claim 1, comprising:
generating, by at least one processor of the computing platform, one or more records comprising the information that identifies the plurality of physical financial documents contemporaneously received by the storage facility for physical financial documents; and
storing, in a memory of the computing platform, the one or more records comprising the information that identifies the plurality of physical financial documents contemporaneously received by the storage facility for physical financial documents.

9. The method of claim 8, comprising:
subsequent to storing the one or more records comprising the information that identifies the plurality of physical financial documents contemporaneously received by the storage facility for physical financial documents, receiving via a communication interface of the computing platform and from a computing device associated with the image processing center for physical financial documents, a message comprising information that identifies one or more additional physical financial documents for reimaging; and
responsive to receiving the message comprising the information that identifies the one or more additional physical financial documents for reimaging:
generating, by at least one processor of the computing platform, one or more records comprising the information that identifies the one or more additional physical financial documents for reimaging;
storing, in a memory of the computing platform, the one or more records comprising the information that identifies the one or more additional physical financial documents for reimaging; and
utilizing, by at least one processor of the computing platform, information from the one or more records comprising the information that identifies the plurality of physical financial documents contemporaneously received by the storage facility for physical financial documents to identify, from amongst the one or more additional physical financial documents for reimaging, at least one physical financial document of the one or more additional physical financial documents for reimaging that is identified by the one or more records comprising the information that identifies the plurality of physical financial documents contemporaneously received by the storage facility for physical financial documents.

10. The method of claim 9, comprising:
generating, by at least one processor of the computing platform, a message indicating that the at least one physical financial document of the one or more additional physical financial documents for reimaging requires reimaging; and
communicating, via a communication interface of the computing platform and to a computing device associated with the storage facility for physical financial documents, the message indicating that the at least one physical financial document of the one or more additional physical financial documents for reimaging requires reimaging.

11. The method of claim 9, comprising:
receiving, via a communication interface of the computing platform and from a computing device associated with the storage facility for physical financial documents, information identifying a physical storage location within the storage facility for physical financial documents for each of the plurality of physical financial documents contemporaneously received by the storage facility for physical financial documents;
utilizing, by at least one processor of the computing platform, the information identifying a physical storage location within the storage facility for physical financial documents for each of the plurality of physical financial documents contemporaneously received by the storage facility for physical financial documents to determine one or more physical storage locations within the storage facility for physical financial documents where the at least one physical financial document of the one or more additional physical financial documents for reimaging is located within the storage facility for physical financial documents;
generating, by at least one processor of the computing platform, a message comprising information identifying the one or more physical storage locations within the storage facility for physical financial documents where the at least one physical financial document of the one or more additional physical financial documents for reimaging is located within the storage facility for physical financial documents; and
communicating, via a communication interface of the computing platform and to a computing device associated with the storage facility for physical financial documents, the message comprising the information identifying the one or more physical storage locations within the storage facility for physical financial documents where the at least one physical financial document of the one or more additional physical financial documents for reimaging is located within the storage facility for physical financial documents.

12. The method of claim 9, comprising:
generating, by at least one processor of a computing device associated with the storage facility for physical financial documents, a message comprising one or more digital images of the at least one physical financial document of the one or more additional physical financial documents for reimaging;
communicating, via a communication interface of a computing device associated with the storage facility for physical financial documents and to a computing device associated with the image processing center for physical financial documents, the message comprising the one or more digital images of the at least one physical financial document of the one or more additional physical financial documents for reimaging;
generating, by at least one processor of a computing device associated with the image processing center for physical financial documents, a message indicating that the one or more digital images of the at least one physical financial document of the one or more additional physical financial documents for reimaging are suitable for processing or that the at least one physical financial document of the one or more additional physical financial documents for reimaging no longer requires reimaging; and
communicating, via a communication interface of a computing device associated with the image processing center for physical financial documents and to the computing platform, the message indicating that the one or more digital images of the at least one physical financial document of the one or more additional physical financial documents for reimaging are suitable for processing or that the at least one physical financial document of the one or more additional physical financial documents for reimaging no longer requires reimaging.

13. The method of claim 12, comprising:
receiving, via a communication interface of the computing platform and from a computing device associated with the image processing center for physical financial documents, the message indicating that the one or more digital images of the at least one physical financial document of the one or more additional physical financial documents for reimaging are suitable for processing or that the at least one physical financial document of the one or more additional physical financial documents for reimaging no longer requires reimaging; and
responsive to receiving the message indicating that the one or more digital images of the at least one physical financial document of the one or more additional physical financial documents for reimaging are suitable for processing or that the at least one physical financial document of the one or more additional physical financial documents for reimaging no longer requires reimaging, altering, by at least one processor of the computing platform, at least one of the one or more records comprising the information that identifies the one or more additional physical financial documents for reimaging to reflect that the at least one physical financial document of the one or more additional physical financial documents no longer requires reimaging.

14. The method of claim 1, comprising:
receiving, via a communication interface of the computing platform and from a computing device associated with a different storage facility for physical financial documents, a message comprising information that identifies a plurality of physical financial documents contemporaneously received by the different storage facility for physical financial documents, said different storage facility for physical financial documents being located in a different geographic area from said storage facility for physical financial documents; and
responsive to receiving the message comprising the information that identifies the plurality of physical financial documents contemporaneously received by the different storage facility for physical financial documents, utilizing, by at least one processor of the computing platform, the information that identifies the plurality of physical financial documents contemporaneously received by the different storage facility for physical financial documents to identify, from amongst the plurality of physical financial documents contemporaneously received by the different storage facility for physical financial documents, at least one physical financial document of the plurality of physical financial documents contemporaneously received by the different storage facility for physical financial documents that is identified by the one or more records comprising the information that identifies the one or more physical financial documents for reimaging.

15. The method of claim 14, comprising:
generating, by at least one processor of the computing platform, a message indicating that the at least one physical financial document of the plurality of physical financial documents contemporaneously received by the different storage facility for physical financial documents requires reimaging; and
communicating, via a communication interface of the computing platform and to a computing device associated with the different storage facility for physical financial documents, the message indicating that the at least one physical financial document of the plurality of physical financial documents contemporaneously received by the different storage facility for physical financial documents requires reimaging.

16. The method of claim 14, comprising:
receiving, via a communication interface of the computing platform and from a computing device associated with the different storage facility for physical financial documents, information identifying a physical storage location within the different storage facility for physical financial documents for each of the plurality of physical financial documents contemporaneously received by the different storage facility for physical financial documents;
utilizing, by at least one processor of the computing platform, the information identifying a physical storage location within the different storage facility for physical financial documents for each of the plurality of physical financial documents contemporaneously received by the different storage facility for physical financial documents to determine one or more physical storage locations within the different storage facility for physical financial documents where the at least one physical financial document of the plurality of physical financial documents contemporaneously received by the different storage facility for physical financial documents is located within the different storage facility for physical financial documents;
generating, by at least one processor of the computing platform, a message comprising information identifying the one or more physical storage locations within the different storage facility for physical financial documents where the at least one physical financial document of the plurality of physical financial documents contemporaneously received by the different storage facility for physical financial documents is located within the different storage facility for physical financial documents; and
communicating, via a communication interface of the computing platform and to a computing device associated with the different storage facility for physical financial documents, the message comprising the information identifying the one or more physical storage locations within the different storage facility for physical financial documents where the at least one physical financial document of the plurality of physical financial documents contemporaneously received by the different storage facility for physical financial documents is located within the different storage facility for physical financial documents.

17. The method of claim 14, comprising:
generating, by at least one processor of a computing device associated with the different storage facility for physical financial documents, a message comprising one or more digital images of the at least one physical financial document of the plurality of physical financial documents contemporaneously received by the different storage facility for physical financial documents;
communicating, via a communication interface of a computing device associated with the different storage facility for physical financial documents and to a computing device associated with the image processing center for physical financial documents, the message comprising the one or more digital images of the at least one physical financial document of the plurality of physical financial documents contemporaneously received by the different storage facility for physical financial documents;
generating, by at least one processor of a computing device associated with the image processing center for physical financial documents, a message indicating that the one or more digital images of the at least one physical financial document of the plurality of physical financial documents contemporaneously received by the different storage facility for physical financial documents are suitable for processing or that the at least one physical financial document of the plurality of physical financial documents contemporaneously received by the different storage facility for physical financial documents no longer requires reimaging; and
communicating, via a communication interface of a computing device associated with the image processing center for physical financial documents and to the computing platform, the message indicating that the one or more digital images of the at least one physical financial document of the plurality of physical financial documents contemporaneously received by the different storage facility for physical financial documents are suitable for processing or that the at least one physical financial document of the plurality of physical financial documents contemporaneously received by the different storage facility for physical financial documents no longer requires reimaging.

18. The method of claim 17, comprising:
receiving, via a communication interface of the computing platform and from a computing device associated with the image processing center for physical financial documents, the message indicating that the one or more digital images of the at least one physical financial document of the plurality of physical financial documents contemporaneously received by the different storage facility for physical financial documents are suitable for processing or that the at least one physical financial document of the plurality of physical financial documents contemporaneously received by the different storage facility for physical financial documents no longer requires reimaging; and
responsive to receiving the message indicating that the one or more digital images of the at least one physical financial document of the plurality of physical financial documents contemporaneously received by the different storage facility for physical financial documents are suitable for processing or that the at least one physical financial document of the plurality of physical financial documents contemporaneously received by the different storage facility for physical financial documents no longer requires reimaging, altering, by at least one processor of the computing platform, at least one of the one or more records comprising the information that identifies the one or more physical financial documents for reimaging to reflect that the at least one physical financial document of the plurality of physical financial documents contemporaneously received by the different storage facility for physical financial documents no longer requires reimaging.

19. A system, comprising:
a computing device associated with a storage facility for physical financial documents, said computing device comprising:
at least one processor;
a communication interface; and
a memory storing instructions that when executed by the at least one processor cause the computing device to:
generate a message comprising information that identifies a plurality of physical financial documents contemporaneously received by the storage facility for physical financial documents; and
communicate, via the communication interface, the message comprising the information that identifies the plurality of physical financial documents contemporaneously received by the storage facility for physical financial documents; and
a computing platform, comprising:
at least one processor;
a communication interface; and
a memory storing instructions that when executed by the at least one processor cause the computing platform to:
receive, via the communication interface and from a computing device associated with an image processing center for physical financial documents, a message comprising information that identifies one or more physical financial documents for reimaging;
generate one or more records comprising the information that identifies the one or more physical financial documents for reimaging;
store, in the memory, the one or more records comprising the information that identifies the one or more physical financial documents for reimaging;
receive, via the communication interface and from the computing device associated with the storage facility for physical financial documents, the message comprising the information that identifies the plurality of physical financial documents contemporaneously received by the storage facility for physical financial documents; and
responsive to receiving the message comprising the information that identifies the plurality of physical financial documents contemporaneously received by the storage facility for physical financial documents, utilize the information that identifies the plurality of physical financial documents contemporaneously received by the storage facility for physical financial documents to identify, from amongst the plurality of physical financial documents contemporaneously received by the storage facility for physical financial documents, at least one physical financial document of the plurality of physical financial documents contemporaneously received by the storage facility for physical financial documents that is identified by the one or more records comprising the information that identifies the one or more physical financial documents for reimaging.

20. One or more non-transitory computer-readable media having instructions stored thereon, that when executed by one or more computers, cause the one or more computers to:
receive, from a computing device associated with an image processing center for physical financial documents, a message comprising information that identifies one or more physical financial documents for reimaging;
generate one or more records comprising the information that identifies the one or more physical financial documents for reimaging;
store, in a memory, the one or more records comprising the information that identifies the one or more physical financial documents for reimaging;
receive, from a computing device associated with a storage facility for physical financial documents, a message comprising information that identifies a plurality of physical financial documents contemporaneously received by the storage facility for physical financial documents; and
responsive to receiving the message comprising the information that identifies the plurality of physical financial documents contemporaneously received by the storage facility for physical financial documents:
utilize the information that identifies the plurality of physical financial documents contemporaneously received by the storage facility for physical financial documents to identify, from amongst the plurality of physical financial documents contemporaneously received by the storage facility for physical financial documents, at least one physical financial document of the plurality of physical financial documents contemporaneously received by the storage facility for physical financial documents that is identified by the one or more records comprising the information that identifies the one or more physical financial documents for reimaging;
generate a message indicating that the at least one physical financial document of the plurality of physical financial documents contemporaneously received by the storage facility for physical financial documents requires reimaging; and
communicate, to a computing device associated with the storage facility for physical financial documents, the message indicating that the at least one physical financial document of the plurality of physical financial documents contemporaneously received by the storage facility for physical financial documents requires reimaging.
